(19) United States
(12) Patent Application Publication
(10) Pub. No.: US 2017/0286324 A1
(43) Pub. Date: Oct. 5, 2017

(54) SEMICONDUCTOR DEVICE AND ACCESS MANAGEMENT METHOD

(71) Applicant: Renesas Electronics Corporation, Tokyo (JP)

(72) Inventor: Yoshitaka TAKI, Tokyo (JP)

(21) Appl. No.: 15/466,761

(22) Filed: Mar. 22, 2017

(30) Foreign Application Priority Data
Apr. 5, 2016 (JP) 2016-075840
Dec. 22, 2016 (JP) 2016-249330

(51) Int. Cl. G06F 12/14

(52) U.S. Cl. CPC G06F 12/1425; G06F 2212/1052

(57) ABSTRACT

A semiconductor device includes a plurality of processing units, a shared resource shared by the plurality of processing units, and a guard unit. The guard unit restricts and thereby controls access to the shared resource by a processing unit, and changes, when a processing unit has failed, control of access so that another processing unit that takes over a process of the failed processing unit is permitted to access at least a part of an access destination which the failed processing unit has been permitted to access.

### CROSS-REFERENCE TO RELATED APPLICATIONS

This application is based upon and claims the benefit of priority from Japanese patent application No. 2016-075840, filed on Apr. 5, 2016, and No. 2016-249330, filed on Dec. 22, 2016, the disclosure of which is incorporated herein in its entirety by reference.

### BACKGROUND

The present invention relates to a semiconductor device and an access management method. For example, the present invention relates to a semiconductor device and an access management method for controlling access to a shared resource.

There are cases where a system needs to continue its operation even when some kind of failure or trouble has occurred. For such systems, various systems referred to as fault-tolerant systems have been known.

For example, Japanese Unexamined Patent Application Publication No. H5-204689 discloses a control device that includes a database configured to hold a group of programs for performing predetermined functions and a group of data such as various information items in advance, a plurality of CPUs, and an interface for peripheral devices, and performs the following control. That is, in the control device disclosed in Japanese Unexamined Patent Application Publication No. H5-204689, a specific CPU among the plurality of CPUs has a management function right to manage processes performed by other CPUs. Based on this management function right, when an abnormality occurs in a given CPU, the specific CPU makes another CPU that is operating normally process a program that has been processed by the failed CPU.

### SUMMARY

The present inventors have found the following problem. In view of the exclusive nature of access to resources, there are cases in which when a given CPU is executing a given process, other CPUs should be prohibited from accessing a resource that is used in the given process. However, in the system disclosed in Japanese Unexamined Patent Application Publication No. H5-204689, each CPU can make a change to the connection switching means. Therefore, there is a problem that whether it is intentional or due to a failure, each CPU can block access or/and perform identity fraud and the like. Therefore, it is desired to provide a fault-tolerant system while securing the exclusive nature of access to resources.

Other objects and novel features will be more apparent from the following description in the specification and the accompanying drawings.

According to one embodiment, when a processing unit fails, a guard unit changes control of access so that another processing unit that takes over a process of the failed processing unit is permitted to access at least a part of an access destination which the failed processing unit has been permitted to access.

According to the above-described embodiment, it is possible to provide a fault-tolerant system while securing the exclusive nature of access to resources.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a rough configuration example of a semiconductor device according to an embodiment;

FIG. 2 is a block diagram showing a rough configuration example of a semiconductor device according to a first embodiment;

FIG. 3 is a block diagram showing an example of a semiconductor device according to a modified example of the first embodiment;

FIG. 4 is a diagram for explaining a structure example of a register C according to the first embodiment;

FIG. 5 is a diagram for explaining a structure example of a register E1 according to the first embodiment;

FIG. 6 is a flowchart showing an example of an operation performed by the semiconductor device according to the first embodiment;

FIG. 7 is a diagram for explaining a structure example of a register E1 according to a second embodiment;

FIG. 8 is a block diagram showing a rough configuration example of a semiconductor device according to a third embodiment;

FIG. 9 is a flowchart showing an example of an operation performed by the semiconductor device according to the third embodiment;

FIG. 10 is a block diagram showing a rough configuration example of a semiconductor device according to a fourth embodiment;

FIG. 11 is a diagram for explaining a structure example of a register D according to the fourth embodiment;

FIG. 12 is a diagram for explaining a structure example of a register F according to the fourth embodiment;

FIG. 13 is a flowchart showing an example of an operation performed by the semiconductor device according to the fourth embodiment;

FIG. 14 is a block diagram showing a rough configuration example of a semiconductor device according to a fifth embodiment;

FIG. 15 is a flowchart showing an example of an operation performed by the semiconductor device according to the fifth embodiment; and

FIG. 16 is a diagram for explaining a structure example of a register F according to a sixth embodiment.

### DETAILED DESCRIPTION

For clarifying the explanation, the following descriptions and the drawings may be partially omitted and simplified as appropriate. Further, the same symbols are assigned to the same components throughout the drawings and duplicated explanations are omitted as required.

### Outline of Embodiment

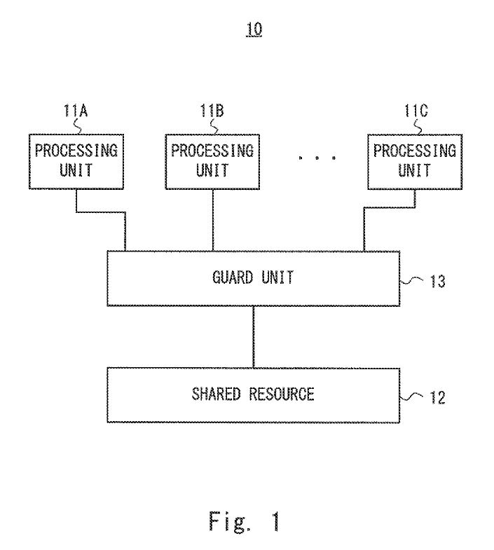

Prior to explaining details of embodiments, their outline is explained hereinafter. FIG. 1 is a block diagram showing a rough configuration example of a semiconductor device 10 according to an embodiment. As shown in FIG. 1, the semiconductor device 10 includes processing units 11A, 11B and 11C, a shared resource 12, and a guard unit 13. Note that three processing units are shown as the processing units in FIG. 1. However, the number of processing units is not limited to three, provided that the semiconductor device 10 includes at least two processing units. Note that in the following explanation, the plurality of processing units 11A, 11B and 11C may be simply referred to as “the processing unit 11” when they do not need to be distinguished from each other. The semiconductor device 10 is a device in which the processing unit 11 accesses the shared resource 12 and performs processing.

The processing unit 11 is hardware (circuit) that accesses the shared resource 12 and performs processing. Examples of the processing unit 11 include processing circuits such as a CPU (Central Processing Unit) and a DMAC (Direct Memory Access controller), but the processing unit 11 is not limited to such processing circuits.

The shared resource 12 is a resource that is shared by a plurality of processing units 11. Examples of the shared resource 12 include resources such as a shared memory, a communication unit such as a CAN (Controller Area Network) unit, a timer, and an AD converter (an analog/digital converter), but the shared resource 12 is not limited to such resources. Further, the shared resource 12 may be one resource or may be a plurality of resources.

The guard unit 13 is hardware (circuit) that restricts access to the shared resource by the processing unit 11. The guard unit 13 restricts and thereby controls access to the shared resource 12 by the processing unit 11. Further, when one of the processing units 11 fails, the guard unit 13 changes the control of access (hereinafter referred to as the “access control”) so that another processing unit 11 that takes over the process of the failed processing unit 11 is permitted to access at least a part of the access destination which the failed processing unit 11 has been permitted to access. For example, assume that in a first state, the processing unit 11A can access the shared resource 12 and the processing units 11B and 11C are prohibited from accessing the shared resource 12. That is, in the first state, the guard unit 13 permits the processing unit 11A to access the shared resource 12 and prohibits the processing units 11B and 11C from accessing the shared resource 12. Here, it is assumed that the processing unit 11 has failed. In a second state which is a state after the failure, the guard unit 13 changes the access control so that another processing unit 11 that is determined to take over the process of the processing unit 11A in advance, e.g., the processing unit 11B is newly permitted to access the shared resource 12. Therefore, the processing unit 11B can take over the process of the processing unit 11A.

As described above, according to the semiconductor device 10, it is possible to secure the exclusive nature of access to resources by the restriction on the access imposed by the guard unit 13. Further, the guard unit 13, triggered by a failure in the processing unit 11, changes the access control so that another processing unit 11 that takes over the process of the failed processing unit 11 is permitted to access the shared resource 12 and thereby makes it possible to continue the desired process. That is, according to the semiconductor device 10, it is possible to provide a fault-tolerant system while securing the exclusive nature of access to resources (hereinafter referred to as “resource access”).

### First Embodiment

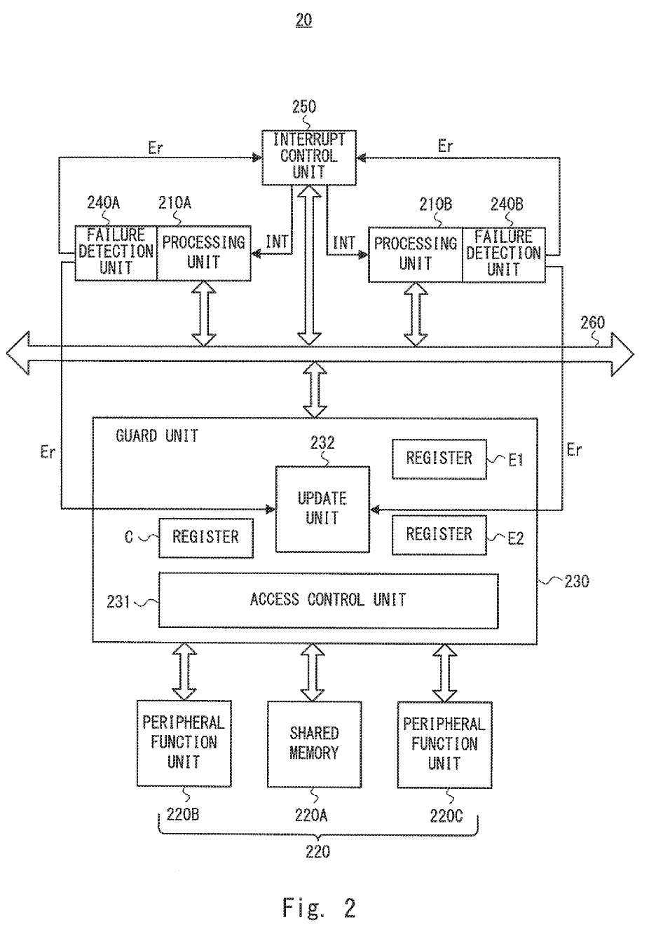

Next, details of an embodiment are explained. FIG. 2 is a block diagram showing a rough configuration example of a semiconductor device 20 according to a first embodiment. As shown in FIG. 2, the semiconductor device 20 includes processing units 210A and 210B, a shared memory 220A, peripheral function units 220B and 220C, a guard unit 230, failure detection units 240A and 240B, and an interrupt control unit 250. Note that two processing units are shown as the processing units in FIG. 2. However, the number of processing units is not limited to two, provided that the semiconductor device 20 includes at least two processing units. Note that in the following explanation, the plurality of processing units 210A and 210B may be simply referred to as “the processing unit 210” when they do not need to be distinguished from each other. Further, the plurality of failure detection units 240A and 240B may be simply referred to as “the failure detection unit 240” when they do not need to be distinguished from each other.

Each of the shared memory 220A and the peripheral function units 220B and 220C is an example of the above-described shared resource 12. Hereinafter, the shared memory 220A and the peripheral function units 220B and 220C are collectively referred to as “the shared resource 220”. Note that three resources, i.e., the shared memory 220A and the peripheral function units 220B and 220C are shown as the shared resources 220 in FIG. 2. However, the number of resources is not limited to three, provided that there is at least one resource. The semiconductor device 20 is a device in which the processing unit 210 accesses the shared resource 220 and performs processing.

The processing unit 210 corresponds to the above-described processing unit 11. That is, the processing unit 210 accesses the shared resource 220 and performs processing. The processing unit 210 is connected to the interrupt control unit 250, the guard unit 230, the shared resource 220, and the like through a bus 260. Note that the failure detection unit 240A is provided as a mechanism for detecting a failure in the processing unit 210A. Further, the failure detection unit 240B is provided as a mechanism for detecting a failure in the processing unit 210B.

The failure detection unit 240 detects a failure in the processing unit 210 by using any of publicly-known failure detection techniques. For example, the failure detection unit 240 detects a failure in the processing unit 210 by using a lock-step technique or the like. Note that the failure detection unit 240 is formed as, for example, hardware (circuit) that detects a failure in the processing unit 210. However, the failure detection unit 240 is not limited to hardware configuration. That is, the failure detection unit 240 may be formed by hardware, firmware, software, or a combination of at least two of them. Each of the failure detection units 240A and 240B outputs an error signal Er. In this embodiment, the failure detection unit 240A is connected to the interrupt control unit 250 through a signal line and is also connected to an update unit 232 of the guard unit 230 through a signal line. Therefore, the error signal Er output from the failure detection unit 240A is input to each of the interrupt control unit 250 and the update unit 232 of the guard unit 230. Similarly, the failure detection unit 240B is connected to the interrupt control unit 250 through a signal line and is also connected to the update unit 232 of the guard unit 230 through a signal line. Therefore, the error signal Er output from the failure detection unit 240B is input to each of the interrupt control unit 250 and the update unit 232 of the guard unit 230. When the failure detection unit 240A detects a failure in the processing unit 210A, the failure detection unit 240A enables the error signal Er (i.e., changes the state of the error signal Er to an enabled state). Further, when the failure detection unit 240B detects a failure in the processing unit 210B, the failure detection unit 240B enables the error signal Er. Note that in the example shown in FIG. 2, the failure detection unit 240 is directly connected to the update unit 232 through the signal line. However, they may be connected to each other with another component such as the interrupt control unit 250 interposed therebetween in order to transmit/receive the error signal Er.

The interrupt control unit 250 is an interrupt controller that controls an interrupt and outputs an interrupt signal INT. When the interrupt control unit 250 receives an enabled error signal Er (an error signal Er in an enabled state), the interrupt control unit 250 enables the interrupt signal INT (i.e., changes the state of the interrupt signal INT to an enabled state). In this embodiment, the interrupt control unit 250 is connected to the processing unit 210A through a signal line and is also connected to the processing unit 210B through a signal line. When the interrupt control unit 250 receives an enabled error signal Er from the failure detection unit 240, the interrupt control unit 250 outputs an enabled interrupt signal INT to another processing unit 210 that is determined in advance as a processing unit that takes over the process performed by the processing unit 210 monitored by the failure detection unit 240. For example, when a processing unit 210 that is determined in advance as a processing unit that takes over the process performed by the processing unit 210A is the processing unit 210B, the interrupt control unit 250 outputs an enabled interrupt signal INT to the processing unit 210B when the interrupt control unit 250 receives an enabled error signal Er from the failure detection unit 240A. Similarly, when a processing unit 210 that is determined in advance as a processing unit that takes over the process performed by the processing unit 210B is the processing unit 210A, the interrupt control unit 250 outputs an enabled interrupt signal INT to the processing unit 210A when the interrupt control unit 250 receives an enabled error signal Er from the failure detection unit 240B. Note that the process performed by one processing unit 210 may be taken over by a plurality of processing units 210. For example, in the case where the semiconductor device 20 includes three processing units 210, when one of the processing units 210 fails, the remaining two processing units 210 may take over the process of the failed processing unit 210.

As described above, in this embodiment, a signal output from the failure detection unit 240 is sent to the processing unit 210 through the interrupt control unit 250. However, the present invention is not limited to such a configuration. For example, the signal output from the failure detection unit 240 may be input to the processing unit 210 that takes over the process through another component(s), or may be directly input to the processing unit 210 that takes over the process. That is, the only requirement is that the semiconductor device should be configured so that a signal resulting from the detection of a failure in a given processing unit 210 is input to another processing unit 210 that takes over the process of the failed processing unit 210 and that the another processing unit 210 that takes over the process can start the execution of the taken-over process.

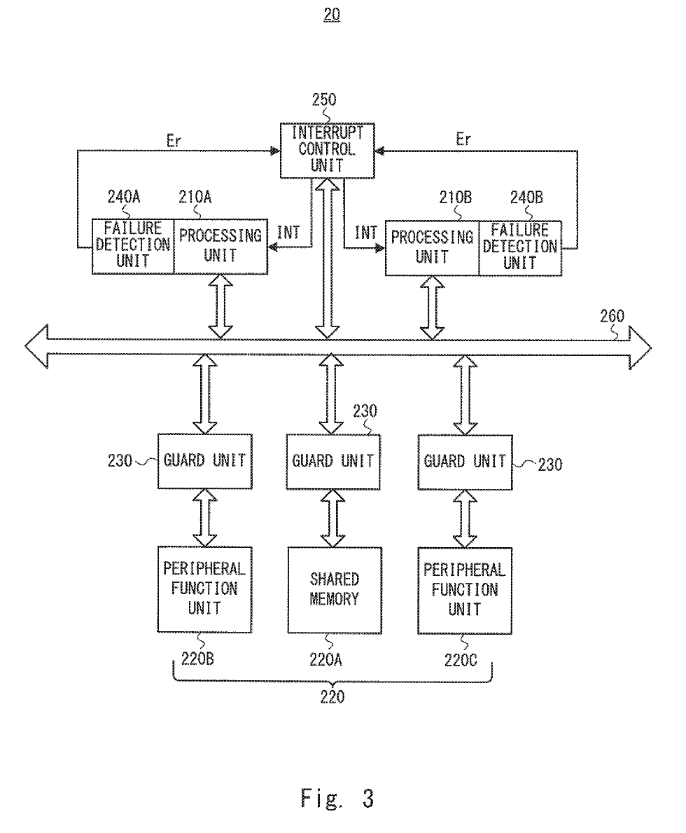

As shown in FIG. 2, the guard unit 230, which corresponds to the above-described guard unit 13, is disposed on the shared resource 220 side of the bus 260. The guard unit 230 includes a register C, registers E1 and E2, an access control unit 231, and an update unit 232. Note that in the example shown in FIG. 2, one guard unit 230 is provided for a plurality of resources. However, as shown in FIG. 3, one guard unit 230 may be provided for each of the resources. That is, at least one guard unit 230 should be provided. Note that in FIG. 3, for easier understanding of the configuration shown in the figure, the sending of the error signal Er from the failure detection unit 240 to the guard unit 230 is omitted. Further, the guard unit 230 may be provided for the interrupt control unit 250 in addition to being provided for the shared resource 220. In this embodiment, the guard unit 230 controls access to the shared resource 220 and access to the guard unit 230 by the processing unit 210.

The register C is an example of an access restriction information storage unit that stores access restriction information specifying a restriction(s) on access to the shared resource 220 and the guard unit 230 by the processing unit 210. Note that the access to the guard unit 230 means access to the register C of the guard unit 230 or access to the register E1 or E2 of the guard unit 230. Note that, in this embodiment, the access restriction information storage unit is formed by a register. However, the access restriction information storage unit may be formed by an arbitrary storage circuit other than the register.

Each of the registers E1 and E2 is an example of an update information storage unit that stores update information for updating the access restriction information stored in the access restriction information storage unit (i.e., stored in the register C). Note that, in this embodiment, the update information storage unit is formed by a register. However, the update information storage unit may be formed by an arbitrary storage circuit other than the register. Note that the register E1 stores update information that is used to update access restriction information when the processing unit 210A has failed. Further, the register E2 stores update information that is used to update access restriction information when the processing unit 210B has failed. Note that it is desirable that the number of update information storage units be equal to the number of processing units 210. However, one update information storage unit may be provided for a plurality of processing units 210.

The access control unit 231 is a control circuit that controls access by the processing unit 210 in accordance with the access restriction information stored in the register C. For example, when access to an access destination is requested by a given processing unit 210, the access control unit 231 determines whether the access to the access destination by that processing unit 210 should be permitted or not in accordance with the access restriction information stored in the register C. Then, when the access should be permitted, the access control unit 231 performs control so that the access is carried out, whereas when the access should not be permitted, the access control unit 231 performs control so that the access is prohibited.

The update unit 232 updates, when a processing unit 210 has failed, the access restriction information stored in the register C so that another processing unit 210 that takes over the process of the failed processing unit 210 is permitted to access at least a part of the access destination which the failed processing unit 210 has been permitted to access. When the update unit 232 receives an enabled error signal Er from the failure detection unit 240A, the update unit 232 updates the access restriction information stored in the register C by using the update information stored in the register E1. Further, when the update unit 232 receives an enabled error signal Er from the failure detection unit 240B, the update unit 232 updates the access restriction information stored in the register C by using the update information stored in the register E2.

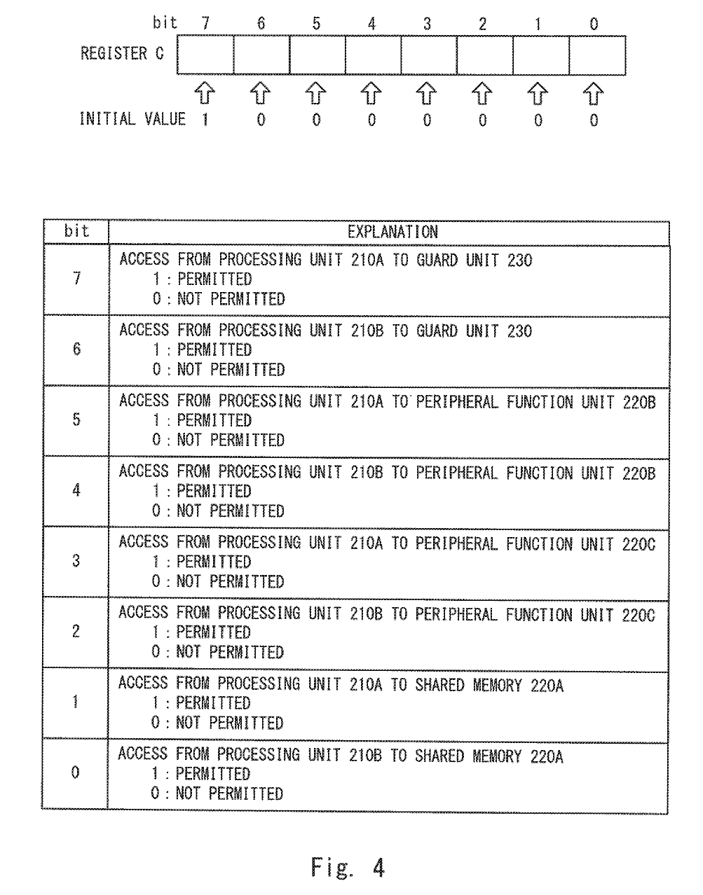

FIG. 4 is a diagram for explaining a structure example of the register C. In the example shown in FIG. 4, the register C is a register whose bit width is 8 bits. Each of the bits holds the following value.

The bit-7 holds a value for specifying permission/prohibition of access from the processing unit 210A to the guard unit 230. Note that when 1 is held in this bit, it means that the access from the processing unit 210A to the guard unit 230 is permitted, whereas when 0 is held in this bit, it means that the access from the processing unit 210A to the guard unit 230 is not permitted.

The bit-6 holds a value for specifying permission/prohibition of access from the processing unit 210B to the guard unit 230. Note that when 1 is held in this bit, it means that the access from the processing unit 210B to the guard unit 230 is permitted, whereas when 0 is held in this bit, it means that the access from the processing unit 210B to the guard unit 230 is not permitted.

The bit-5 holds a value for specifying permission/prohibition of access from the processing unit 210A to the peripheral function unit 220B. Note that when 1 is held in this bit, it means that the access from the processing unit 210A to the peripheral function unit 220B is permitted, whereas when 0 is held in this bit, it means that the access from the processing unit 210A to the peripheral function unit 220B is not permitted.

The bit-4 holds a value for specifying permission/prohibition of access from the processing unit 210B to the peripheral function unit 220B. Note that when 1 is held in this bit, it means that the access from the processing unit 210B to the peripheral function unit 220B is permitted, whereas when 0 is held in this bit, it means that the access from the processing unit 210B to the peripheral function unit 220B is not permitted.

The bit-3 holds a value for specifying permission/prohibition of access from the processing unit 210A to the peripheral function unit 220C. Note that when 1 is held in this bit, it means that the access from the processing unit 210A to the peripheral function unit 220C is permitted, whereas when 0 is held in this bit, it means that the access from the processing unit 210A to the peripheral function unit 220C is not permitted.

The bit-2 holds a value for specifying permission/prohibition of access from the processing unit 210B to the peripheral function unit 220C. Note that when 1 is held in this bit, it means that the access from the processing unit 210B to the peripheral function unit 220C is permitted, whereas when 0 is held in this bit, it means that the access from the processing unit 210B to the peripheral function unit 220C is not permitted.

The bit-1 holds a value for specifying permission/prohibition of access from the processing unit 210A to the shared memory 220A. Note that when 1 is held in this bit, it means that the access from the processing unit 210A to the shared memory 220A is permitted, whereas when 0 is held in this bit, it means that the access from the processing unit 210A to the shared memory 220A is not permitted.

The bit-0 holds a value for specifying permission/prohibition of access from the processing unit 210B to the shared memory 220A. Note that when 1 is held in this bit, it means that the access from the processing unit 210B to the shared memory 220A is permitted, whereas when 0 is held in this bit, it means that the access from the processing unit 210B to the shared memory 220A is not permitted.

Note that in the example shown in FIG. 4, the register C (C[7:0]) holds 8b′1000_0000 as an initial value. That is, when the register C is in this state, the access control unit 231 permits only the access from the processing unit 210A to the guard unit 230 and prohibits the access from the processing unit 210A to the shared resource 220 and the access from the processing unit 210B to the guard unit 230 and the shared resource 220.

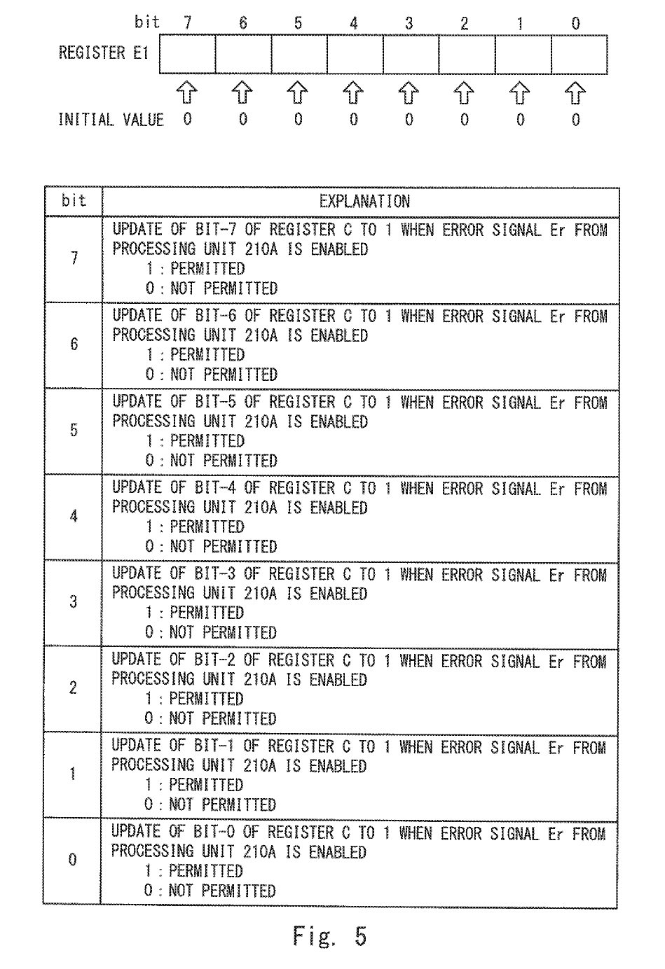

Next, a structure example of the registers E1 and E2 is explained by using a specific example. Note that in the below-shown example, the registers E1 and E2 have similar structures, except that the processing units 210 associated with them are different from each other. Therefore, a specific structure example of only the register E1 is described below and the explanation of the structure of the register E2 is omitted. FIG. 5 is a diagram for explaining a structure example of the register E1. Note that each of the registers E1 and E2 is a register whose bit width is 8 bits. As shown in FIG. 5, each of the bits of the register E1 holds the following value.

The bit-7 holds a value for specifying permission/prohibition of writing of 1 into the bit-7 of the register C when the error signal Er from the processing unit 210A (the failure detection unit 240A) is enabled. Note that when 1 is held in this bit, it means that when the processing unit 210A has failed, the value in the bit-7 of the register C is updated to 1 by the update unit 232. That is, after the update by the update unit 232, the access from the processing unit 210A to the guard unit 230 is permitted. On the other hand, when 0 is held in this bit, it means that when the processing unit 210A has failed, the value in the bit-7 of the register C is not updated to 1 by the update unit 232. That is, even after the update by the update unit 232, the permission/prohibition state of the access from the processing unit 210A to the guard unit 230 is not changed.

The bit-6 holds a value for specifying permission/prohibition of writing of 1 into the bit-6 of the register C when the error signal Er from the processing unit 210A (the failure detection unit 240A) is enabled. Note that when 1 is held in this bit, it means that when the processing unit 210A has failed, the value in the bit-6 of the register C is updated to 1 by the update unit 232. That is, after the update by the update unit 232, the access from the processing unit 210B to the guard unit 230 is permitted. On the other hand, when 0 is held in this bit, it means that when the processing unit 210A has failed, the value in the bit-6 of the register C is not updated to 1 by the update unit 232. That is, even after the update by the update unit 232, the permission/prohibition state of the access from the processing unit 210B to the guard unit 230 is not changed.

The bit-5 holds a value for specifying permission/prohibition of writing of 1 into the bit-5 of the register C when the error signal Er from the processing unit 210A (the failure detection unit 240A) is enabled. Note that when 1 is held in this bit, it means that when the processing unit 210A has failed, the value in the bit-5 of the register C is updated to 1 by the update unit 232. That is, after the update by the update unit 232, the access from the processing unit 210A to the peripheral function unit 220B is permitted. On the other hand, when 0 is held in this bit, it means that when the processing unit 210A has failed, the value in the bit-5 of the register C is not updated to 1 by the update unit 232. That is, even after the update by the update unit 232, the permission/prohibition state of the access from the processing unit 210A to the peripheral function unit 220B is not changed.

The bit-4 holds a value for specifying permission/prohibition of writing of 1 into the bit-4 of the register C when the error signal Er from the processing unit 210A (the failure detection unit 240A) is enabled. Note that when 1 is held in this bit, it means that when the processing unit 210A has failed, the value in the bit-4 of the register C is updated to 1 by the update unit 232. That is, after the update by the update unit 232, the access from the processing unit 210B to the peripheral function unit 220B is permitted. On the other hand, when 0 is held in this bit, it means that when the processing unit 210A has failed, the value in the bit-4 of the register C is not updated to 1 by the update unit 232. That is, even after the update by the update unit 232, the permission/prohibition state of the access from the processing unit 210B to the peripheral function unit 220B is not changed.

The bit-3 holds a value for specifying permission/prohibition of writing of 1 into the bit-3 of the register C when the error signal Er from the processing unit 210A (the failure detection unit 240A) is enabled. Note that when 1 is held in this bit, it means that when the processing unit 210A has failed, the value in the bit-3 of the register C is updated to 1 by the update unit 232. That is, after the update by the update unit 232, the access from the processing unit 210A to the peripheral function unit 220C is permitted. On the other hand, when 0 is held in this bit, it means that when the processing unit 210A has failed, the value in the bit-3 of the register C is not updated to 1 by the update unit 232. That is, even after the update by the update unit 232, the permission/prohibition state of the access from the processing unit 210A to the peripheral function unit 220C is not changed.

The bit-2 holds a value for specifying permission/prohibition of writing of 1 into the bit-2 of the register C when the error signal Er from the processing unit 210A (the failure detection unit 240A) is enabled. Note that when 1 is held in this bit, it means that when the processing unit 210A has failed, the value in the bit-2 of the register C is updated to 1 by the update unit 232. That is, after the update by the update unit 232, the access from the processing unit 210B to the peripheral function unit 220C is permitted. On the other hand, when 0 is held in this bit, it means that when the processing unit 210A has failed, the value in the bit-2 of the register C is not updated to 1 by the update unit 232. That is, even after the update by the update unit 232, the permission/prohibition state of the access from the processing unit 210B to the peripheral function unit 220C is not changed.

The bit-1 holds a value for specifying permission/prohibition of writing of 1 into the bit-1 of the register C when the error signal Er from the processing unit 210A (the failure detection unit 240A) is enabled. Note that when 1 is held in this bit, it means that when the processing unit 210A has failed, the value in the bit-1 of the register C is updated to 1 by the update unit 232. That is, after the update by the update unit 232, the access from the processing unit 210A to the shared memory 220A is permitted. On the other hand, when 0 is held in this bit, it means that when the processing unit 210A has failed, the value in the bit-1 of the register C is not updated to 1 by the update unit 232. That is, even after the update by the update unit 232, the permission/prohibition state of the access from the processing unit 210A to the shared memory 220A is not changed.

The bit-0 holds a value for specifying permission/prohibition of writing of 1 into the bit-0 of the register C when the error signal Er from the processing unit 210A (the failure detection unit 240A) is enabled. Note that when 1 is held in this bit, it means that when the processing unit 210A has failed, the value in the bit-0 of the register C is updated to 1 by the update unit 232. That is, after the update by the update unit 232, the access from the processing unit 210B to the shared memory 220A is permitted. On the other hand, when 0 is held in this bit, it means that when the processing unit 210A has failed, the value in the bit-0 of the register C is not updated to 1 by the update unit 232. That is, even after the update by the update unit 232, the permission/prohibition state of the access from the processing unit 210B to the shared memory 220A is not changed.

Note that in the example shown in FIG. 5, the register E1 (E1[7:0]) holds 8b′0000_0000 as an initial value. Further, similarly, the register E2 (E2[7:0]) may hold 8b′0000_0000 as an initial value. In such a case, the update unit 232 does not update the value of the register C even when the processing unit 210 has failed. As described later, in this embodiment, the initial values of the register C and the registers E1 and E2 are changed by an initialization operation.

In FIGS. 4 and 5, an example in which the permission or non-permission of access is specified for each resource of the shared resource 220 is shown. However, the permission or non-permission of access can be specified on the basis of an arbitrarily-determined unit. For example, a plurality of resources may be handled as one resource unit. Alternatively, one resource may be divided into a plurality of sections and the permission or non-permission of access may be specified for each section. Further, a resource may be divided into a plurality of sections according to the address. For example, a memory address space of a system may be divided into a plurality of sections according to the address. Note that the memory address space may correspond to the whole of a plurality of resources or may correspond to a part of the plurality of resources.

Further, in the example shown in FIGS. 4 and 5, the permission or non-permission of access is specified for each of the entities that access the shared resource (hereinafter referred to as “accessing entities”). However, the permission or non-permission of access may be specified for each of combinations of the accessing entities and other conditions. Note that examples of the other conditions include an access type (i.e., whether the access is read access or write access), a type of an operating mode of an accessing entity (i.e., whether the mode is a user mode or a privilege mode), and information about a process. The permission or non-permission of access may be specified each of combinations of at least one of these conditions and the accessing entities.

Note that each of the register C and the registers E1 and E2 may be combined into one register (i.e., formed as one register) as shown in the figure or may be divided into a plurality of registers. Further, the above-shown initial value of each bit of each register is merely an example. That is, they may be arbitrarily changed according to the characteristic of the system.

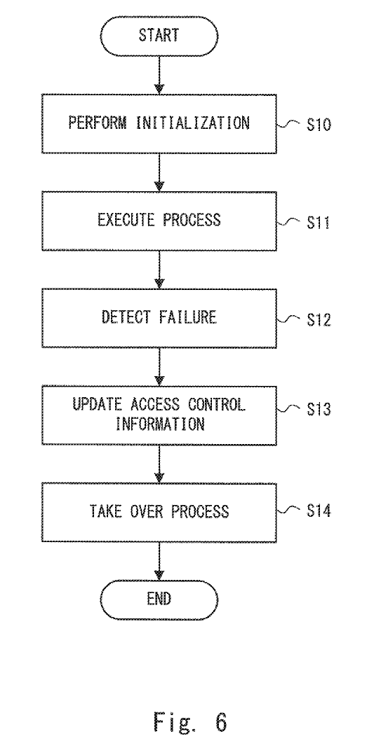

Next, an operation of the semiconductor device 20 is explained. FIG. 6 is a flowchart showing an example of an operation performed by the semiconductor device 20. The operation of the semiconductor device 20 is explained hereinafter along the flowchart shown in FIG. 6. Note that since an operation that is performed when a failure occurs is explained below, an example of an operation in which a failure occurs is shown by the flowchart.

In a step 10 (S10), the semiconductor device 20 carries out the initialization of the system. For example, the processing unit 210A sets a value to each of the register C and the registers E1 and E2 of the guard unit 230. The value set in the register C in the step 10 is a value that is determined based on the system specifications as to which of the processing units 210 should perform a process by using which of the shared resources 220 before any failure occurs in the processing units 210. Further, the value set in the register E1 in the step 10 is a value that is determined based on the system specifications as to which of the processing units 210 should take over a process (the whole or apart of a process) that has been performed by the processing unit 210A when a failure occurs in the processing unit 210A. Similarly, the value set in the register E2 in the step 10 is a value that is determined based on the system specifications as to which of the processing units 210 should take over a process (the whole or a part of a process) that has been performed by the processing unit 210B when a failure occurs in the processing unit 210B.

Note that an example in which the processing unit 210A performs the initialization is described above. To enable the processing unit 210A to perform the initialization, the initialization value of the register C needs to be set in advance as shown in FIG. 4. That is, it is necessary that the processing unit 210A has been permitted to access the guard unit 230. As described previously, the initial value of the register C is not limited to the value shown in FIG. 4. Therefore, depending on the initial value of the register C, another processing unit 210 or the like may perform the initialization.

Further, in the step 10, the interrupt control unit 250 is also set based on the above-described system specifications. Specifically, the interrupt control unit 250 is set so that when an error signal Er output from a failure detection unit 240 that detects a failure in a processing unit 210 from which a process is taken over (hereinafter referred to as a “transfer-origin processing unit 210”) is enabled, the interrupt control unit 250 notifies a processing unit 210 to which the process is taken over (hereinafter referred to as a “transfer-destination processing unit 210”) by using an interrupt signal INT.

Next, in a step 11 (S11), each of the processing units 210 of the semiconductor device 20 performs a process defined as a system. It is desirable that a technique for facilitating the taking-over of a process (hereinafter also referred to as “the transfer of a process”) when a failure occurs be incorporated in this process. Various techniques can be applied as such a technique. An example of such a technique is a technique in which a checkpoint in a checkpoint restart is stored in the shared resource 220A or the like.

Next, in a step 12 (S12), the failure detection unit 240 detects a failure. Upon detection the failure, the failure detection unit 240 enables the error signal Er (i.e., changes the state of the error signal Er to an enabled state).

Next, in a step 13 (S13), when the error signal Er is enabled, the update unit 232 of the guard unit 230 updates the value in the register C based on the value of one of the registers E1 and E2 corresponding to the failed processing unit 210. Further, the interrupt control unit 250 notifies the transfer-destination processing unit 210 of the error signal Er output from the failure detection unit 240 based on the above-described initialization by enabling the interrupt signal INT (i.e., by changing the state of the interrupt signal INT to an enabled state).

Next, in a step 14 (S14), upon receiving the enabled interrupt signal INT, the processing unit 210 takes over, among the processes that have been executed by the failed processing unit 210, a process(es) that has been determined to be taken over in advance and executes the taken-over process(es). Note that as described above, various techniques such as a checkpoint restart can be applied to the transfer of the process.

A specific example of the initialization in the step 10 and the update in the step 13 is explained hereinafter. Note that it is assumed that the register C and the registers E1 and E2 have the following values before the initialization, i.e., as initial values. The register C holds 8b′1000_0000 as an initial value. Each of the registers E1 and E2 holds 8b′0000_0000 as an initial value. Further, assume that it is specified in the system specifications that the processing unit 210A performs processes using the shared memory 220A and the peripheral function unit 220B before a failure occurs in the processing unit 210A. Similarly, assume that it is specified in the system specifications that the processing unit 210B performs processes using the shared memory 220A and the peripheral function unit 220C before a failure occurs in the processing unit 210B. Further, assume that it is specified in the system specifications that when a failure occurs in the processing unit 210A, the processing unit 210B takes over the process of the processing unit 210A. Similarly, assume that it is specified in the system specifications that when a failure occurs in the processing unit 210B, the processing unit 210A takes over the process of the processing unit 210B.

In such a case, the register C (C[7:0]) is set so as to hold 8b′0010_0111 by the initialization in the step 10. Further, the register E1 (E1[7:0]) is set so as to hold 8b′0001_0000. Further, the register E2 (E2[7:0]) is set so as to hold 8b′0000_1000.

Then, when the processing unit 210A fails in the step 13, the register C (C[7:0]) is set so as to hold 8b′0011_0111 by an update that is performed based on the register E1. As a result, the processing unit 210B is newly permitted to access the peripheral function unit 220B and hence be able to take over the process of the processing unit 210A. Note that this update operation is carried out by, for example, performing OR-calculation (i.e., logical summation calculation) of the bit string of the register C and that of the register E1 as shown in the below-shown Expression (1).

C[7:0]=C[7:0]|E1[7:0] (1)

Further, when the processing unit 210B fails in the step 13, the register C (C[7:0]) is set so as to hold 8b′0010_1111 by an update that is performed based on the register E2. As a result, the processing unit 210A is newly permitted to access the peripheral function unit 220C and hence be able to take over the process of the processing unit 210B. Note that this update operation is carried out by, for example, performing OR-calculation of the bit string of the register C and that of the register E2 as shown above.

The first embodiment has been explained above. According to the semiconductor device 20 in accordance with this embodiment, it is possible to secure the exclusive nature of resource access by the restriction on the access imposed by the guard unit 230. Further, when a failure in a processing unit 210 is detected by the failure detection unit 240, the update unit 232 of the guard unit 230 updates the access restriction information so that another processing unit 210 that takes over the process of the failed processing unit 210 can execute the taken-over process. Therefore, the semiconductor device 20 can continue the process even when a failure occurs in the processing unit 210. That is, according to the semiconductor device 20 in accordance with this embodiment, it is possible to provide a fault-tolerant system while securing the exclusive nature of resource access.

Further, according to the semiconductor device 20 in accordance with this embodiment, the guard unit 230 controls access to the guard unit 230 by the processing unit 210 in addition to access to the shared resource 220 by the processing unit 210. Then, when a failure occurs in the processing unit 210, the guard unit 230 can also change the control of access to the guard unit 230 by the processing unit 210. Therefore, even if a processing unit 210 that is permitted to access the guard unit 230 fails before the completion of the initialization, it is possible to change the access control so that another processing unit 210 can access the guard unit 230. Accordingly, even when a processing unit 210 that is permitted to access the guard unit 230 fails before the completion of the initialization, a desired process can be executed. Consequently, it is possible to provide a system that is more fault-tolerant. Note that to cope with a failure that occurs in a processing unit 210 that is permitted to access the guard unit 230 before the completion of the initialization as described above, the initial value of the register E1 or E2, for example, may be set so that another processing unit 210 that takes over the initialization process can access the guard unit 230. That is, the guard unit 230 may restrict and thereby control access to the guard unit 230 itself, so that when a processing unit 210 that is permitted to access the guard unit 230 has failed, another processing unit 210 other than the failed processing unit 210 may be permitted to access the guard unit 230.

### Second Embodiment

Next, a second embodiment is explained. Differences from the first embodiment are explained hereinafter in detail and explanations of configurations and operations similar to those of the first environment are omitted. In the semiconductor device 20 according to the first embodiment, when a failure occurs in a processing unit 210, the update unit 232 of the guard unit 230 changes the access control so that another processing unit 210 that takes over the process of the failed processing unit 210 can access the access destination necessary for the transfer of the process.

In contrast to this, when a failure occurs in a processing unit 210, a semiconductor device 20 according to this embodiment not only changes the access control as described above in the first embodiment, but also changes the access control so that a predetermined processing unit 210 is prohibited from accessing a predetermined access destination. Specifically, for example, when a processing unit 210 has failed, the update unit 232 of the guard unit 230 according to this embodiment changes, in addition to changing the access control as described above in the first embodiment, the access control so that access by the failed processing unit 210 is prohibited. Note that the update performed by the update unit 232 is similar to that in the first embodiment. That is, when the update unit 232 according to this embodiment receives an enabled error signal Er from the failure detection unit 240A, the update unit 232 updates the access restriction information stored in the register C by using the update information stored in the register E1. Further, when the update unit 232 according to this embodiment receives an enabled error signal Er from the failure detection unit 240B, the update unit 232 updates the access restriction information stored in the register C by using the update information stored in the register E2.

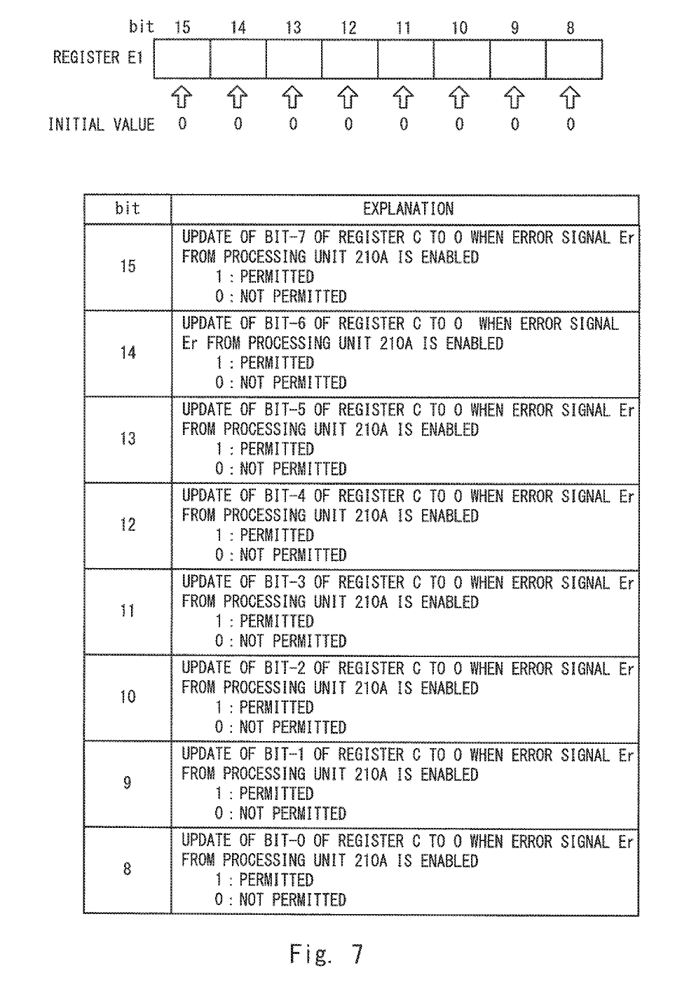

FIG. 7 is a diagram for explaining a structure example of the register E1 according to the second embodiment. Note that in the below-shown example, the registers E1 and E2 have similar structures, except that the processing units 210 associated with them are different from each other. Therefore, a specific structure example of only the register E1 is described below and the explanation of the structure of the register E2 is omitted. Note that each of the registers E1 and E2 according to this embodiment is a register whose bit width is 16 bits. Specifically, each of the registers E1 and E2 according to this embodiment includes additional 8 bits as bits for changing access control so as to prohibit access in addition to the 8 bits shown in the first embodiment. Note that FIG. 7 shows only the additional high-order 8 bits. In the example shown in FIG. 7, the register E1 includes additional 8 bits, i.e., bit-15 to bit-8 as bits for changing access control so as to prohibit access in addition to the 8 bits shown in the first embodiment. For example, as shown in FIG. 7, each of the bits of the register E1 holds the following value.

The bit-15 holds a value for specifying permission/prohibition of writing of 0 into the bit-7 of the register C when the error signal Er from the processing unit 210A (the failure detection unit 240A) is enabled. Note that when 1 is held in this bit, it means that when the processing unit 210A has failed, the value in the bit-7 of the register C is updated to 0 by the update unit 232. That is, after the update by the update unit 232, the access from the processing unit 210A to the guard unit 230 is prohibited. On the other hand, when 0 is held in this bit, it means that when the processing unit 210A has failed, the value in the bit-7 of the register C is not updated to 0 by the update unit 232. That is, even after the update by the update unit 232, the permission/prohibition state of the access from the processing unit 210A to the guard unit 230 is not changed.

The bit-14 holds a value for specifying permission/prohibition of writing of 0 into the bit-6 of the register C when the error signal Er from the processing unit 210A (the failure detection unit 240A) is enabled. Note that when 1 is held in this bit, it means that when the processing unit 210A has failed, the value in the bit-6 of the register C is updated to 0 by the update unit 232. That is, after the update by the update unit 232, the access from the processing unit 210B to the guard unit 230 is prohibited. On the other hand, when 0 is held in this bit, it means that when the processing unit 210A has failed, the value in the bit-6 of the register C is not updated to 0 by the update unit 232. That is, even after the update by the update unit 232, the permission/prohibition state of the access from the processing unit 210B to the guard unit 230 is not changed.

The bit-13 holds a value for specifying permission/prohibition of writing of 0 into the bit-5 of the register C when the error signal Er from the processing unit 210A (the failure detection unit 240A) is enabled. Note that when 1 is held in this bit, it means that when the processing unit 210A has failed, the value in the bit-5 of the register C is updated to 0 by the update unit 232. That is, after the update by the update unit 232, the access from the processing unit 210A to the peripheral function unit 220B is prohibited. On the other hand, when 0 is held in this bit, it means that when the processing unit 210A has failed, the value in the bit-5 of the register C is not updated to 0 by the update unit 232. That is, even after the update by the update unit 232, the permission/prohibition state of the access from the processing unit 210A to the peripheral function unit 220B is not changed.

The bit-12 holds a value for specifying permission/prohibition of writing of 0 into the bit-4 of the register C when the error signal Er from the processing unit 210A (the failure detection unit 240A) is enabled. Note that when 1 is held in this bit, it means that when the processing unit 210A has failed, the value in the bit-4 of the register C is updated to 0 by the update unit 232. That is, after the update by the update unit 232, the access from the processing unit 210B to the peripheral function unit 220B is prohibited. On the other hand, when 0 is held in this bit, it means that when the processing unit 210A has failed, the value in the bit-4 of the register C is not updated to 0 by the update unit 232. That is, even after the update by the update unit 232, the permission/prohibition state of the access from the processing unit 210B to the peripheral function unit 220B is not changed.

The bit-11 holds a value for specifying permission/prohibition of writing of 0 into the bit-3 of the register C when the error signal Er from the processing unit 210A (the failure detection unit 240A) is enabled. Note that when 1 is held in this bit, it means that when the processing unit 210A has failed, the value in the bit-3 of the register C is updated to 0 by the update unit 232. That is, after the update by the update unit 232, the access from the processing unit 210A to the peripheral function unit 220C is prohibited. On the other hand, when 0 is held in this bit, it means that when the processing unit 210A has failed, the value in the bit-3 of the register C is not updated to 0 by the update unit 232. That is, even after the update by the update unit 232, the permission/prohibition state of the access from the processing unit 210A to the peripheral function unit 220C is not changed.

The bit-10 holds a value for specifying permission/prohibition of writing of 0 into the bit-2 of the register C when the error signal Er from the processing unit 210A (the failure detection unit 240A) is enabled. Note that when 1 is held in this bit, it means that when the processing unit 210A has failed, the value in the bit-2 of the register C is updated to 0 by the update unit 232. That is, after the update by the update unit 232, the access from the processing unit 210B to the peripheral function unit 220C is prohibited. On the other hand, when 0 is held in this bit, it means that when the processing unit 210A has failed, the value in the bit-2 of the register C is not updated to 0 by the update unit 232. That is, even after the update by the update unit 232, the permission/prohibition state of the access from the processing unit 210B to the peripheral function unit 220C is not changed.

The bit-9 holds a value for specifying permission/prohibition of writing of 0 into the bit-1 of the register C when the error signal Er from the processing unit 210A (the failure detection unit 240A) is enabled. Note that when 1 is held in this bit, it means that when the processing unit 210A has failed, the value in the bit-1 of the register C is updated to 0 by the update unit 232. That is, after the update by the update unit 232, the access from the processing unit 210A to the shared memory 220A is prohibited. On the other hand, when 0 is held in this bit, it means that when the processing unit 210A has failed, the value in the bit-1 of the register C is not updated to 0 by the update unit 232. That is, even after the update by the update unit 232, the permission/prohibition state of the access from the processing unit 210A to the shared memory 220A is not changed.

The bit-8 holds a value for specifying permission/prohibition of writing of 0 into the bit-0 of the register C when the error signal Er from the processing unit 210A (the failure detection unit 240A) is enabled. Note that when 1 is held in this bit, it means that when the processing unit 210A has failed, the value in the bit-0 of the register C is updated to 0 by the update unit 232. That is, after the update by the update unit 232, the access from the processing unit 210B to the shared memory 220A is prohibited. On the other hand, when 0 is held in this bit, it means that when the processing unit 210A has failed, the value in the bit-0 of the register C is not updated to 0 by the update unit 232. That is, even after the update by the update unit 232, the permission/prohibition state of the access from the processing unit 210B to the shared memory 220A is not changed.

Note that in the example shown in FIG. 7, the register E1 (E1[15:0]) holds 8b′0000_0000_0000_0000 as an initial value. Further, similarly, the register E2 (E2[15:0]) may hold 8b′0000_0000_0000_0000 as an initial value. In such a case, the update unit 232 does not update the value of the register C even when the processing unit 210 has failed.

Next, an operation of the semiconductor device 20 according to this embodiment is explained. Note that in the following explanation, the flowchart for the semiconductor device 20 according to the first embodiment shown in FIG. 6 is used. Further, the following explanation is given with particular emphasis on differences from the operation of the semiconductor device 20 according to the first embodiment.

In a step 10 (S10), the semiconductor device 20 carries out the initialization of the system. Note that for each of the registers E1 and E2, the semiconductor device 20 according to this embodiment sets a value for the above-described additional high-order 8 bits in addition to the 8 bits shown in the first embodiment. Note that in this embodiment, the value (i.e., the bit values) set to the register E1 in the step 10 includes a value (i.e., bit values) that is determined based on the system specifications as to which of the processing units 210 should take over a process (the whole or a part of a process) that has been performed by the processing unit 210A when a failure occurs in the processing unit 210A, and a value (i.e., bit values) that is determined based on the system specifications as to which of the processing units 210 should be prohibited from accessing which access destination when the processing unit 210A has failed. As an example of the initialization for the prohibition of access, a value for prohibiting accessing to an originally-permitted access destination by the failed processing unit 210A is set. Similarly, in this embodiment, the value (i.e., the bit values) set to the register E2 in the step 10 includes a value (i.e., bit values) that is determined based on the system specifications as to which of the processing units 210 should take over a process (the whole or a part of a process) that has been performed by the processing unit 210B when a failure occurs in the processing unit 210B, and a value (i.e., bit values) that is determined based on the system specifications as to which of the processing units 210 should be prohibited from accessing which access destination when the processing unit 210B has failed. As an example of the initialization for the prohibition of access, a value for prohibiting accessing to an originally-permitted access destination by the failed processing unit 210B is set.

Next, in a step 11 (S11), each of the processing units 210 of the semiconductor device 20 performs a process defined as a system. Then, in a step 12 (S12), the failure detection unit 240 detects a failure.

Then, in a step 13 (S13), when the error signal Er is enabled, the update unit 232 according to this embodiment, based on the value of one of the registers E1 and E2 corresponding to the failed processing unit 210, changes the access control so that another processing unit 210 that takes over the process of the failed processing unit 210 can access the access destination necessary for the transfer of the process, and changes the access control so that access by a predetermined processing unit 210 (e.g., the failed processing unit 210) is prohibited. Further, the interrupt control unit 250 notifies the transfer-destination processing unit 210 of the error signal Er output from the failure detection unit 240 by enabling the interrupt signal INT.

Next, in a step 14 (S14), upon receiving the enabled interrupt signal INT, the processing unit 210 takes over, among the processes that have been executed by the failed processing unit 210, a process(es) that has been determined to be taken over in advance and execute the taken-over process(es).

A specific example of a value of a register in this embodiment is shown hereinafter. Note that it is assumed that the register C and the registers E1 and E2 have the following values before the completion of the initialization, i.e., as initial values. The register C holds 8b′1000_0000 as an initial value. Each of the registers E1 and E2 holds 8b′0000_0000_0000_0000 as an initial value. Further, assume that it is specified in the system specifications that the processing unit 210A performs processes using the shared memory 220A and the peripheral function unit 220B before a failure occurs in the processing unit 210A. Similarly, assume that it is specified in the system specifications that the processing unit 210B performs processes using the shared memory 220A and the peripheral function unit 220C before a failure occurs in the processing unit 210B. Further, assume that it is specified in the system specifications that when a failure occurs in the processing unit 210A, the processing unit 210B takes over the process of the processing unit 210A. Similarly, assume that it is specified in the system specifications that when a failure occurs in the processing unit 210B, the processing unit 210A takes over the process of the processing unit 210B. Furthermore, assume that it is specified in the system specifications that when the processing unit 210A has failed, the processing unit 210A is prohibited from accessing the access destination which the processing unit 210A has been originally permitted to access. Similarly, assume that it is specified in the system specifications that when the processing unit 210B has failed, the processing unit 210B is prohibited from accessing the access destination which the processing unit 210B has been originally permitted to access.

In such a case, the register C (C[7:0]) is set so as to hold 8b′0010_0111 by the initialization in the step 10. Further, the register E1 (E1[15:0]) is set so as to hold 8b′0010_0010_0001_0000. Further, the register E2 (E2[15:0]) is set so as to hold 8b′0000_0101_0000_1000.

Then, when the processing unit 210A fails in the step 13, the register C (C[7:0]) is set so as to hold 8b′0001_0101 by an update that is performed based on the register E1. As a result, the processing unit 210B is newly permitted to access the peripheral function unit 220B and hence be able to take over the process of the processing unit 210A. Further, the processing unit 210A is prohibited from accessing the shared memory 220A and the peripheral function unit 220B. Note that this update operation is carried out by, for example, performing OR-calculation (i.e., logical summation calculation) of the bit string of the register C and the bit string of the low-order 8 bits of the register E1 and then performing AND-calculation (i.e., logical multiplication calculation) of the result of the OR-calculation and the inverted value of the bit string of the high-order 8 bits of the register E1 as shown in the below-shown Expression (2).

C[7:0]=C[7:0]|E1[7:0]&!E1[15:8] (2)

Further, when the processing unit 210B fails in the step 13, the register C (C[7:0]) is set so as to hold 8b′0010_1010 by an update that is performed based on the register E2. As a result, the processing unit 210A is newly permitted to access the peripheral function unit 220C and hence be able to take over the process of the processing unit 210B. Further, the processing unit 210B is prohibited from accessing the shared memory 220A and the peripheral function unit 220C. Note that this update operation is carried out by, for example, performing OR-calculation of the bit string of the register C and the bit string of the low-order 8 bits of the register E2 and then performing AND-calculation of the result of the OR-calculation and the inverted value of the bit string of the high-order 8 bits of the register E2 as shown above.

The second embodiment has been explained above. As described previously, when a failure occurs in a processing unit 210, the semiconductor device 20 according to this embodiment changes the access control so that another processing unit 210 that takes over the process of the failed processing unit 210 can access the access destination necessary for the transfer of the process, and changes the access control so that access by the failed processing unit 210 is prohibited. As described above, in this embodiment, when the register C is updated at the time of the failure of the processing unit 210, the register C can be updated for prohibiting access as well as for permitting access. In this way, since access from the failed processing unit 210 can be blocked, a malfunction which would otherwise be caused by the failed processing unit 210 can be prevented. Further, in the case where various information items indicating processing states and the like are stored, it is possible to prevent such various information items from being corrupted due to access from the failed processing unit 210. As described above, according to this embodiment, it is possible to provide a system with higher security than that for the semiconductor device 20 according to the first embodiment. Note that in the above-shown embodiment, an example in which the registers E1 and E2 of the first embodiment are extended is shown. However, instead of extending the registers E1 and E2, separate registers (i.e., additional registers) may be provided to prohibit access when the processing unit 210 has failed.

### Third Embodiment

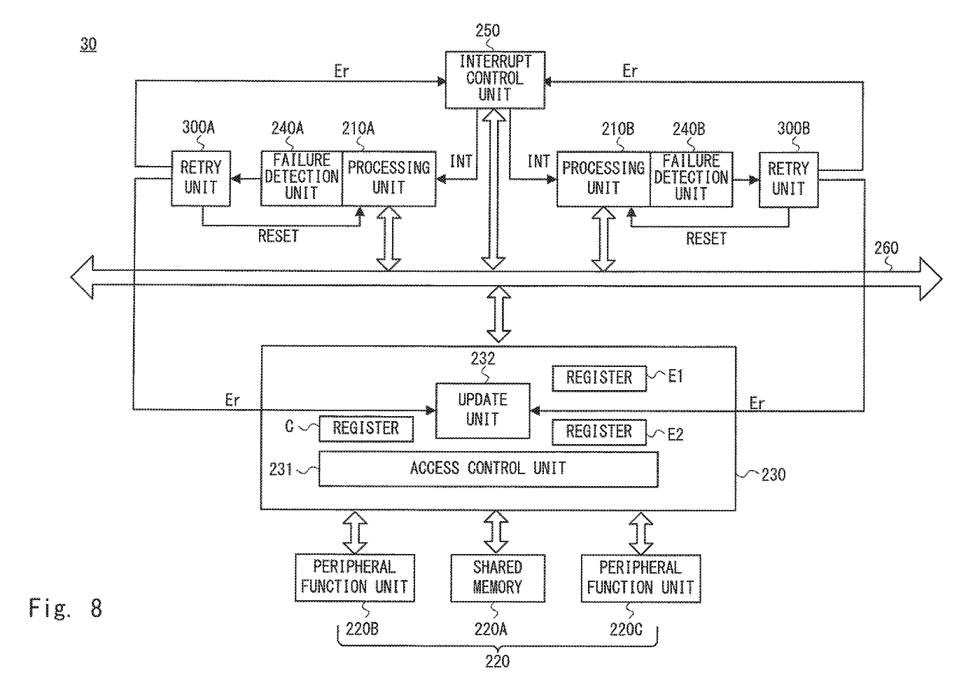

In the above-described embodiments, when a failure in the processing unit 210 is detected even only once, the access control is changed. In contrast to this, in this embodiment, the access control is changed when a failure in the same processing unit 210 is detected more than a predetermined number of times. FIG. 8 is a block diagram showing a rough configuration example of a semiconductor device 30 according to a third embodiment. As shown in FIG. 8, the semiconductor device 30 differs from the semiconductor device 20 in that the semiconductor device 30 includes retry units 300A and 300B. For the configuration and the operation of the semiconductor device 30, only differences from those of the semiconductor device 20 are explained hereinafter in detail and explanations of configurations and operations similar to those of the semiconductor device 20 are omitted as appropriate. Note that in the following explanation, the plurality of retry units 300A and 300B may be simply referred to as “the retry unit 300” when they do not need to be distinguished from each other. Note that the retry unit 300 shown in this embodiment may be added in the semiconductor device 20 according to the first embodiment and in the semiconductor device 20 according to the second embodiment.

The retry unit 300A is a retry control circuit that transmits a reset signal to the processing unit 210A and thereby resets the processing unit 210A every time a failure in the processing unit 210A is detected. The retry unit 300B is a retry control circuit that transmits a reset signal to the processing unit 210B and thereby resets the processing unit 210B every time a failure in the processing unit 210B is detected. Note that in the example shown in FIG. 8, the retry unit 300A is disposed between a signal line of an error signal Er output from the failure detection unit 240A and signal lines of error signals Er input to the guard unit 230 and the interrupt control unit 250. Further, the retry unit 300B is disposed between a signal line of an error signal Er output from the failure detection unit 240B and signal lines of error signals Er input to the guard unit 230 and the interrupt control unit 250. Further, the retry unit 300 resets the processing unit 210 in which the failure is detected (hereinafter referred to as the “failure-detected processing unit 210”) when the error signal Er output from the failure detection unit 240 is enabled (i.e., the state of the error signal Er is changed to an enabled state).

The retry unit 300A enables each of the error signal Er that is output from the retry unit 300A and input to the guard unit 230 and the error signal Er that is output from the retry unit 300A and input to the interrupt control unit 250 when the error signal Er output from the failure detection unit 240A is enabled more than a predetermined number of times. Further, similarly, the retry unit 300B enables each of the error signal Er that is output from the retry unit 300B and input to the guard unit 230 and the error signal Er that is output from the retry unit 300B and input to the interrupt control unit 250 when the error signal Er output from the failure detection unit 240B is enabled more than a predetermined number of times.

When the error signal Er from the retry unit 300 is enabled, the access control is changed by the guard unit 230 and the process is taken over as explained above in the first and second embodiments. Therefore, the guard unit 230 according to this embodiment changes the access control when the number of times of the detection of a failure exceeds the predetermined number in any of the processing units 210. Note that the same predetermined number may be used for all of the retry units 300 or different predetermined numbers may be used for them. Further, the retry unit 300 may include a register or the like in which a number that is used as a threshold is set. Further, the retry unit 300 may include a register or the like in which information about an entity to be reset by the retry unit 300 is set. Note that in such a case, the retry unit 300 may be connected to the bus 260 and may be connected to the bus 260 through the guard unit 230. That is, various embodiments may be used as desired.

Note that in the configuration example shown in FIG. 8, the retry unit 300 outputs the reset signal only to the failure-detected processing unit 210. However, the retry unit 300 may output a reset signal to a component(s) other than the failure-detected processing unit 210 and thereby reset that component(s). For example, the retry unit 300 may reset the shared resource 220 that is permitted to be accessed by the failure-detected processing unit 210 in addition to the failure-detected processing unit 210 itself. It is conceivable that when a failure in the processing unit 210 is detected, an abnormality also occurs in the access destination of that processing unit 210. However, by adopting the above-described configuration, it is possible to reset not only the processing unit 210 itself but also its access destination.

Further, in the example shown in FIG. 8, the retry unit 300 is disposed between the signal line of the error signal Er output from the failure detection unit 240A and the signal lines of the error signals Er input to the guard unit 230 and the interrupt control unit 250. However, this configuration is merely an example and other various configurations may be implemented. For example, a part or the whole of each of the above-described function of the retry unit 300 may be integrated with the function of the guard unit 230 or the interrupt control unit 250. That is, for example, the function of masking the error signal Er output from the failure detection unit 240 (i.e., putting the error signal Er output from the failure detection unit 240 on hold) for a predetermined number of times before outputting it to the guard unit 230 in the retry unit 300 may be implemented on the guard unit 230 side. Further, for example, the function of masking the error signal Er output from the failure detection unit 240 for a predetermined number of times before outputting it to the interrupt control unit 250 in the retry unit 300 may be implemented on the interrupt control unit 250 side.

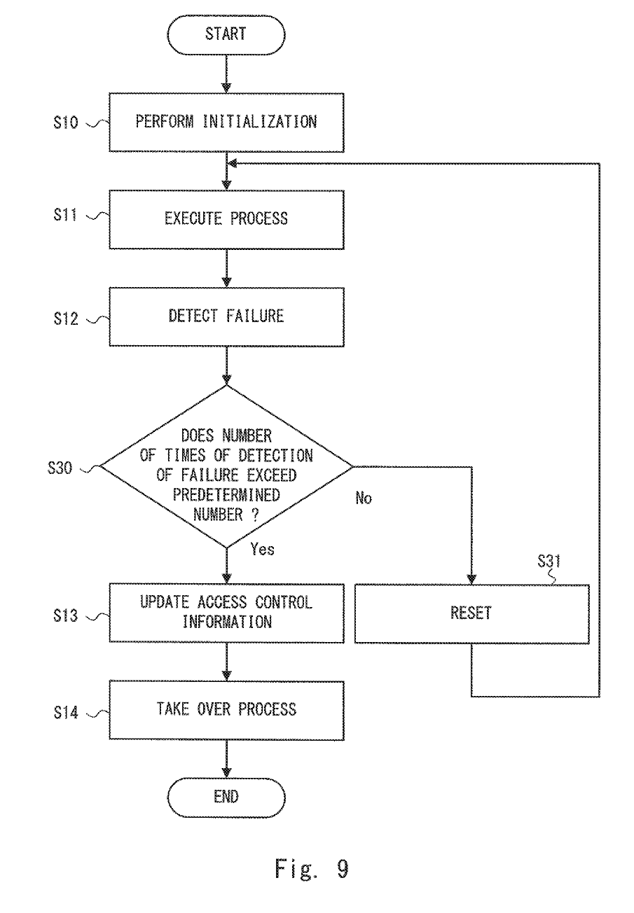

Next, an operation of the semiconductor device 30 is explained. FIG. 9 is a flowchart showing an example of an operation performed by the semiconductor device 30. The operation of the semiconductor device 30 is explained hereinafter along the flowchart shown in FIG. 9. Note that since an operation that is performed when a failure occurs is explained below, an example of an operation in which a failure occurs is shown by the flowchart. The flowchart shown in FIG. 9 differs from the flowchart shown in FIG. 6 in that the flowchart shown in FIG. 9 includes steps 30 and 31. The following explanation is given with particular emphasis on differences from the flowchart shown in FIG. 6.

Operations that are performed from the initialization to the failure detection are the same as those of the semiconductor device 20. Here, in the flowchart shown in FIG. 6, the process moves to the step 13 after the step 12. However, in this embodiment, the process moves to a step 30 after the step 12.

In the step 30 (S30), the retry unit 300 determines whether or not the number of times of the detection of a failure in the same processing unit 210 exceeds a predetermined number. When the number of times of the detection of a failure in the same processing unit 210 has exceeded the predetermined number (Yes at step 30), the retry unit 300 enables the error signal Er output to the interrupt control unit 250 and the guard unit 230. Then, the process moves to the step 13. On the other hand, when the number of times of the detection of a failure in the same processing unit 210 has not exceeded the predetermined number (No at step 30), the process moves to a step 31. In the step 31 (S31), the retry unit 300 resets the failure-detected processing unit 210. Then, the process returns to the step 11.

In the semiconductor device 30, when a failure detection unit 240 corresponding to a given processing unit 210 detects a failure therein, the failure detection unit 240 enables the error signal Er. However, until the error signal Er output from the failure detection unit 240 is enabled more than the number of times specified by the implementation of the retry unit 300, the error signal Er output from the retry unit 300 to the guard unit 230 and the interrupt control unit 250 is not enabled and a reset signal is output to the failure-detected processing unit 210. The processing unit 210, which has been restarted by the reset, resumes the process by using a technique such as a checkpoint restart. Then, when the error signal Er output from the failure detection unit 240 is enabled more than the specified number of times, the error signal Er output from the retry unit 300 to the guard unit 230 and the interrupt control unit 250 is enabled and the operations in the step 13 and the subsequent steps in the flowchart shown in FIG. 6 are performed.

As described above, according to the semiconductor device 30, even when a failure is detected, the access control is not changed until the number of times of the detection exceeds the predetermined number. Therefore, it is possible to prevent the total processing capability of the system from being lowered due to transitory failures such as soft errors. Note that in the above-described semiconductor device 30, until a failure in the processing unit 210 is detected more than the predetermined number of times, the guard unit 230 and the interrupt control unit 250 are not notified of the failure. However, a signal indicating the detection of a failure in a processing unit 210 may be output to other processing units 210 before the number of the times of the detection exceeds the predetermined number. For example, in a system in which a plurality of processing units 210 perform cooperative operations, a processing unit 210 may have to perform a process with consideration given to the effect that is caused when another processing unit 210 with which the processing unit 210 is cooperating is reset due to the detection of a failure in that processing unit 210. In such a case, it is desirable that when a failure in a processing unit 210 is detected even only once, the retry unit 300 notify another processing unit(s) 210 (i.e., a processing unit(s) 210 cooperating with the failure-detected processing unit 210) of the detection of the failure in that failure-detected processing unit 210.

### Fourth Embodiment

Next, a fourth embodiment is explained. In this embodiment, a system in which each processing unit transmits identification information (hereinafter called a “task ID”) corresponding to a process (i.e., a task) as sideband information of a bus and a guard unit controls whether access should be permitted or prohibited according to this identification information is explained. Note that as described above, the task ID is identification information for identifying a process.

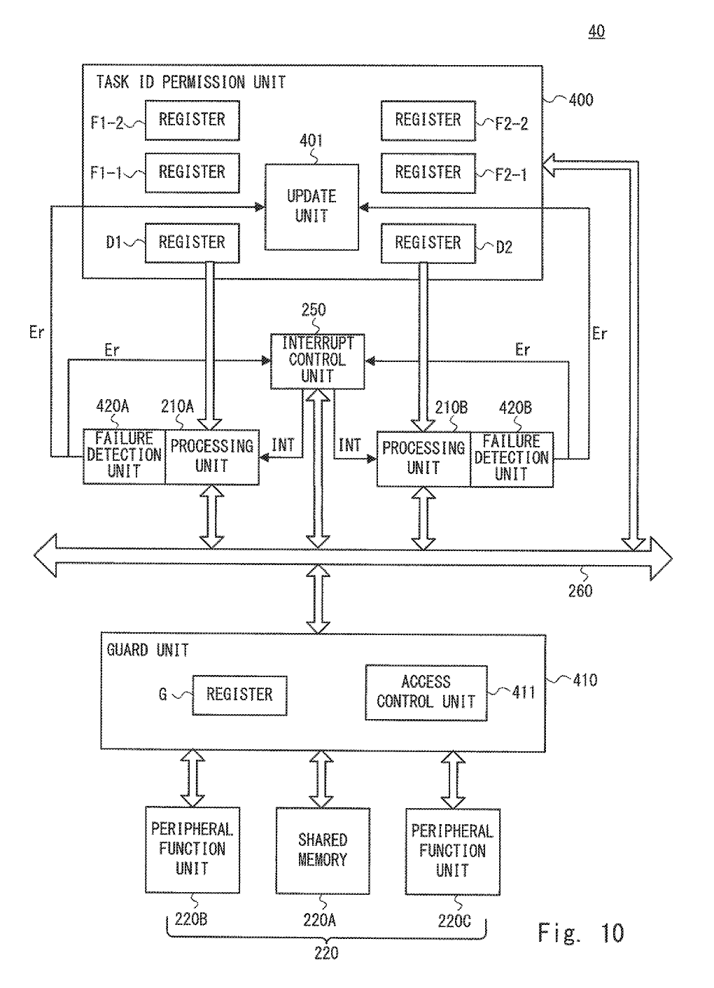

FIG. 10 is a block diagram showing a rough configuration example of a semiconductor device 40 according to a fourth embodiment. As shown in FIG. 10, the semiconductor device 40 differs from the semiconductor device 20 according to the first embodiment in that: a task ID permission unit 400 is added; the guard unit 230 is replaced by a guard unit 410; and the failure detection units 240A and 240B are replaced by failure detection units 420A and 420B, respectively. Note that the number of processing units 210 is not limited two in this embodiment. That is, the number of processing units 210 may be three or more. Further, three resources, i.e., the shared memory 220A and the peripheral function units 220B and 220C are shown as the shared resources 220 in this embodiment. However, the number of resources is not limited to three, provided that there is at least one resource. For the configuration and the operation of the semiconductor device 40, only differences from those of the semiconductor device 20 are explained hereinafter in detail and explanations of configurations and operations similar to those of the semiconductor device 20 are omitted as appropriate. Note that in the following explanation, the plurality of failure detection units 420A and 420B may be simply referred to as “the failure detection unit 420” when they do not need to be distinguished from each other.

The failure detection unit 420A is identical to the failure detection unit 240A, except that the output destination of the error signal Er is different. Similarly, the failure detection unit 420B is identical to the failure detection unit 240B, except that the output destination of the error signal Er is different. In this embodiment, the failure detection unit 420A is connected to the interrupt control unit 250 through a signal line and is also connected to an update unit 401 (which will be described later) of the task ID permission unit 400 through a signal line. Therefore, an error signal Er output from the failure detection unit 420A is input to each of the interrupt control unit 250 and the update unit 401 of the task ID permission unit 400. Similarly, the failure detection unit 420B is connected to the interrupt control unit 250 through a signal line and is also connected to the update unit 401 of the task ID permission unit 400 through a signal line. Therefore, an error signal Er output from the failure detection unit 420B is input to each of the interrupt control unit 250 and the update unit 401 of the task ID permission unit 400. Note that the various modified examples described in the first embodiment can also be applied to this embodiment as long as no contradiction arises. For example, in the example shown in FIG. 10, the failure detection unit 420 is directly connected to the update unit 401 through the signal line. However, they may be connected to each other with another component such as the interrupt control unit 250 interposed therebetween in order to transmit/receive the error signal Er. Further, in the example shown in FIG. 10, a signal output from the failure detection unit 420 is sent to the processing unit 210 through the interrupt control unit 250 (i.e., by using the interrupt signal INT). However, the present invention is not limited to such a configuration. For example, the signal output from the failure detection unit 420 may be input to the processing unit 210 that takes over the process through another component(s), or may be directly input to the processing unit 210 that takes over the process. That is, the only requirement is that the semiconductor device should be configured so that a signal resulting from the detection of a failure in a given processing unit 210 is input to another processing unit 210 that takes over the process of the failed processing unit 210 and the another processing unit 210 that takes over the process can start the execution of the taken-over process.

The task ID permission unit 400 is also referred to as a “management unit”. The task ID permission unit 400 is connected to the bus 260. Therefore, the processing unit 210 is connected to the interrupt control unit 250, the task ID permission unit 400, and the shared resource 220 through the bus 260. The task ID permission unit 400 manages, for each processing unit 210, identification information that can be used by that processing unit 210 for the task ID. The task ID permission unit 400 includes registers D1 and D2, registers F1-1 and F1-2, registers F2-1 and F2-2, and the update unit 401. In the following explanation, the registers D1 and D2 may be simply referred to as “the register D” when they do not need to be distinguished from each other. Similarly, the registers F1-1, F1-2, F2-1 and F2-2 may be simply referred to as “the register F” when they do not need to be distinguished from each other.

The register D is an example of a management information storage unit that stores management information for specifying a task ID(s) that can be used by the processing unit 210. The management information indicates a task ID(s) that can be used by each processing unit 210. In the configuration example shown in FIG. 10, the register D1 stores management information indicating a task ID(s) that can be used by the processing unit 210A and the register D2 stores management information indicating a task ID(s) that can be used by the processing unit 210B. Note that, in this embodiment, the management information storage unit is formed by a register. However, the management information storage unit may be formed by an arbitrary storage circuit other than the register.

The register F is an example of a management update information storage unit that stores update information for updating the management information stored in the management information storage unit (i.e., in the register D). The management information indicates how each register D should be updated when one of the processing units 210 has failed. In the configuration example shown in FIG. 10, the register F1-1 stores update information that is used to update the register D1 when the processing unit 210A has failed and the register F1-2 stores update information that is used to update the register D1 when the processing unit 210B has failed. Further, the register F2-1 stores update information that is used to update the register D2 when the processing unit 210A has failed and the register F2-2 stores update information that is used to update the register D2 when the processing unit 210B has failed. Note that, in this embodiment, the management update information storage unit is formed by a register. However, the management update information storage unit may be formed by an arbitrary storage circuit other than the register.

It is desirable that the number of registers D be equal to the number of processing units 210 as shown in FIG. 10. However, for example, one register D may be provided for a plurality of processing units 210. That is, various configurations are possible. Further, it is desirable that the number of registers F for each register D be equal to the number of processing units 210 as shown in FIG. 10. However, for example, one register F may be provided for a plurality of processing units 210. That is, various configurations are possible.

The update unit 401 is also referred to as a “management information update unit”. The update unit 401 changes, when a processing unit 210 has failed, the management so that another processing unit 210 that takes over the process of the failed processing unit 210 can use the task ID corresponding to the taken-over process. Specifically, the update unit 401 updates the management information stored in the register D by using the update information stored in the register F. That is, when the update unit 401 receives an enabled error signal Er from the failure detection unit 420A, the update unit 401 updates the management information stored in the register D1 by using the update information stored in the register F1-1 and updates the management information stored in the register D2 by using the update information stored in the register F2-1. Similarly, when the update unit 401 receives an enabled error signal Er from the failure detection unit 420B, the update unit 401 updates the management information stored in the register D1 by using the update information stored in the register F1-2 and updates the management information stored in the register D2 by using the update information stored in the register F2-2.

Next, the processing unit 210 according to this embodiment is explained. The processing unit 210 according to this embodiment is similar to the processing unit 210 according to the above-described embodiments. However, in this embodiment, in particular, the processing unit 210 performs a process (a task) corresponding to a task ID that is managed (i.e., recorded) as available to the processing unit 210 (i.e., as being able to be used by the processing unit 210) in the task ID permission unit 400. For example, the processing unit 210 refers to the register D. Then, the processing unit 210 executes a task corresponding to a task ID that the processing unit 210 is permitted to use, but does not execute a task corresponding to a task ID that the processing unit 210 is not permitted to use. That is, in this embodiment, it is possible to restrict tasks that each processing unit 210 can execute by the setting of the task IDs. Note that the restriction of task IDs may be controlled by the processing unit 210 as described above. Alternatively, the restriction may be controlled by other control mechanisms (not shown). Further, the processing unit 210 according to this embodiment notifies the guard unit 410 of the task ID corresponding to the task to be executed when the processing unit 210 accesses the shared resource 220.

The guard unit 410 controls access by the processing unit 210 according to the task ID notified from the processing unit 210. Therefore, in this embodiment, the guard unit 410 performs the following operation. The guard unit 410 changes, when a processing unit 210 has failed, the control of access by the processing unit 210 according to the change in the management information made by the task ID permission unit 400. Specifically, when a processing unit 210 has failed, the guard unit 410 changes the access control so that another processing unit 210 that takes over the process of the failed processing unit 210 is permitted to access at least a part of the access destination which the failed processing unit 210 has been permitted to access in accordance with the result of the update of the management information. That is, the guard unit 230 according to the first embodiment performs, when a processing unit 210 has failed, the above-described control change in accordance with the result of the update of the access restriction information performed by the update unit 232. In contrast to this, the guard unit 410 according to this embodiment performs the above-described control change in accordance with the result of the update of the management information performed by the update unit 401.

The guard unit 410 includes a register G and an access control unit 411. Note that in the example shown in FIG. 10, one guard unit 410 is provided for a plurality of resources. However, as in the case of the example shown in FIG. 3, one guard unit 410 may be provided for each of the resources. That is, at least one guard unit 410 should be provided. Further, the guard unit 410 may also be provided for the interrupt control unit 250 or the task ID permission unit 400 in addition for the shared resource 220.

The register G is an example of an access restriction information storage unit that stores access restriction information specifying a restriction(s) on access to the shared resource 220 and the guard unit 410 by the processing unit 210. Note that the access to the guard unit 410 means access to, for example, the register G of the guard unit 410. The register G in this embodiment stores, for example, information indicating permission/prohibition of access for each task ID as access restriction information for each of the shared resource 220 and the guard unit 410. However, the information stored in the register G is not limited to this example. That is, the register G may also store information indicating permission/prohibition of access for each task ID for the task ID permission unit 400. Note that the access to the task ID permission unit 400 means access to, for example, the registers D and the register F of the task ID permission unit 400. Note that, in this embodiment, the access restriction information storage unit is formed by a register. However, the access restriction information storage unit may be formed by an arbitrary storage circuit other than the register.

The access control unit 411 is a control circuit that controls access by the processing unit 210 in accordance with the access restriction information stored in the register G. For example, when access to an access destination is requested by a given processing unit 210, the access control unit 411 determines whether the access to the access destination by that processing unit 210 should be permitted or not in accordance with the task ID that is notified when the access is requested and the access restriction information stored in the register G. Then, when the access should be permitted, the access control unit 411 performs control so that the access is carried out, whereas when the access should not be permitted, the access control unit 411 performs control so that the access is prohibited.

As described above, the update unit 401 of the task ID permission unit 400 changes, when a processing unit 210 has failed, the management so that another processing unit 210 that takes over the process of the failed processing unit 210 can use the task ID corresponding to the taken-over process. Therefore, when the another processing unit 210, which has taken over the process of the failed processing unit 210, requests access using the task ID corresponding to the taken-over process, the access control unit 411 permits this access.

Note that in this embodiment, the permission or non-permission of access is specified for each task ID. However, the permission or non-permission of access may be determined for, instead of only each task ID, each accessing entity, each access type, each operating mode type of the accessing entity, or each combination of them.

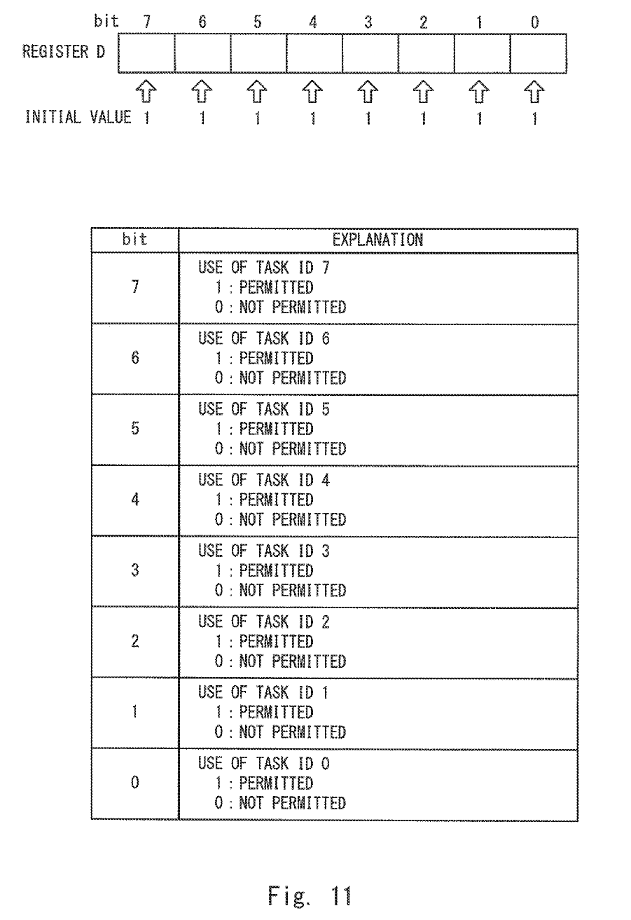

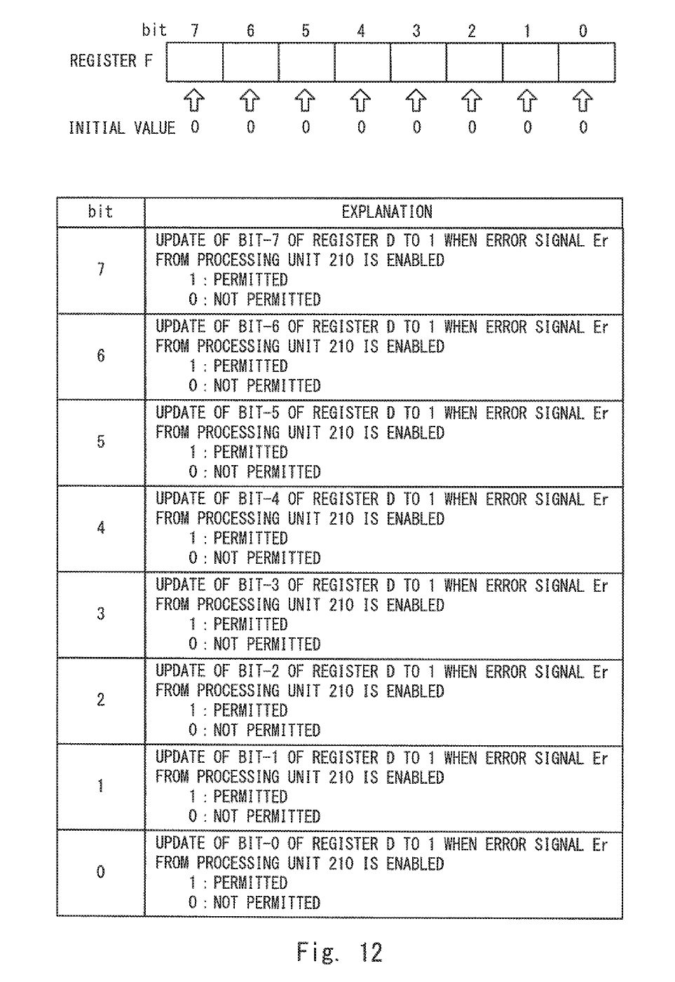

Next, a specific example of each register of the task ID permission unit 400 is explained. FIG. 11 is a diagram for explaining a structure example of the register D. Note that each of FIG. 11 and the later-described FIG. 12 shows an example in which the system is configured so that each processing unit 210 is permitted to use up to eight types of task IDs. In the example shown in FIG. 11, the register D is a register whose bit width is 8 bits. Each of the bits holds the following value. Hereinafter, the eight types of task IDs are represented by task ID 0 to task ID 7, respectively.

The bit-7 holds a value for specifying permission/prohibition of use of the task ID 7 by the processing unit 210. Note that when 1 is held in this bit, it means that the use of the task ID 7 by the processing unit 210 is permitted, whereas when 0 is held in this bit, it means that the use of the task ID 7 by the processing unit 210 is not permitted. That is, for example, when 1 is held in the bit-7 of the register D1, the processing unit 210A can execute a task corresponding to the task ID 7. Further, for example, when 0 is held in the bit-7 of the register D1, the processing unit 210A cannot execute the task corresponding to the task ID 7. The above-described matters hold true for each of the bit-6 to bit-0 of the register D. That is, bit-K (K is 7 to 0) of the register D holds a value for specifying permission/prohibition of use of the task ID K by the processing unit 210.

Note that in the example shown in FIG. 11, the register D (D[7:0]) holds 8b′1111_1111 as an initial value. That is, when the register D is in this state, the processing unit 210 is permitted to use all the task IDs. However, the initial value of each bit shown in FIG. 11 is merely an example. That is, they may be arbitrarily changed according to the characteristic of the system.

FIG. 12 is a diagram for explaining a structure example of the register F. In the example shown in FIG. 12, the register F is a register whose bit width is 8 bits. Each of the bits holds the following value.

The bit-7 holds a value for specifying permission/prohibition of writing of 1 into the bit-7 of the register D when the error signal Er from the failure detection unit 420 is enabled. Note that when 1 is held in this bit, it means that when the processing unit 210 has failed, the value in the bit-7 of the register D is updated to 1 by the update unit 401. That is, after the update by the update unit 401, the use of the task ID 7 by the processing unit 210 corresponding to this register D is permitted. On the other hand, when 0 is held in this bit, it means that when the processing unit 210 has failed, the value in the bit-7 of the register D is not updated to 1 by the update unit 401. That is, the permission/prohibition state of the use of the task ID 7 by the processing unit 210 corresponding to this register D is not changed.

For example, when a failure occurs in the processing unit 210A, the register D1 is updated by using the register F1-1 and the register D2 is updated by using the register F2-1. In this process, for example, when 0 is held in the bit-7 of the register F1-1, the register D1 is updated by the update unit 401 but the permission/prohibition state of the use of the task ID 7 by the processing unit 210A is not changed. Further, for example, when 1 is held in the bit-7 of the register F2-1, the register D2 is updated by the update unit 401 and the use of the task ID 7 by the processing unit 210B is permitted.

The above-described matters hold true for each of the bit-6 to bit-0 of the register F. That is, the bit-K (K is 7 to 0) of the register F holds a value for specifying the permission/prohibition of writing of 1 into the bit-K of the register D (i.e., a value for specifying the permission/prohibition of the change for permitting the use of the task ID K) when the error signal Er from the failure detection unit 420 is enabled.

Note that in the example shown in FIG. 12, the register F (F[7:0]) holds 8b′0000_0000 as an initial value. That is, when the register F is in this state, the value of the register D is not changed when the processing unit 210 has failed. However, the initial value of each bit shown in FIG. 12 is merely an example. That is, they may be arbitrarily changed according to the characteristic of the system.

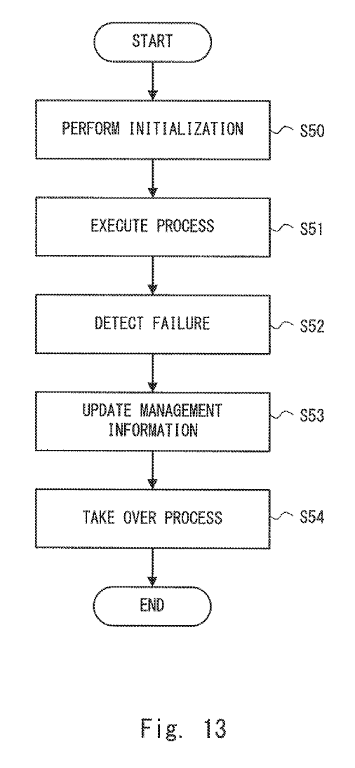

Next, an operation of the semiconductor device 40 is explained. FIG. 13 is a flowchart showing an example of an operation performed by the semiconductor device 40. The operation of the semiconductor device 40 is explained hereinafter along the flowchart shown in FIG. 13. Note that since an operation that is performed when a failure occurs is explained below, an example of an operation in which a failure occurs is shown by the flowchart.

In a step 50 (S50), the semiconductor device 40 carries out the initialization of the system. For example, the processing unit 210A sets a value to each of the registers D1 and D2, the registers F1-1 and F1-2, the registers F2-1 and F2-2 of the task ID permission unit 400, and the register G of the guard unit 410. The value set in the register D in the step 50 is a value that is determined based on the system specifications as to which of the processing units 210 should perform a process by using which of the task IDs before any failure occurs in the processing units 210. Further, the value set in the register F in the step 50 is a value that is determined based on the system specifications as to which of the processing units 210 should take over, when a failure occurs in a processing unit 210, a process (the whole or a part of a process) that has been performed by the failed processing unit 210. Further, the value set in the register G in the step 50 is a value that is determined based on the system specifications as to which of the shared resources 220 should be permitted to be accessed for which of the tasks. Note that an example in which the processing unit 210A performs the initialization is described above. However, needless to say, depending on the configuration of the system, other components may perform the initialization.

Further, in the step 50, the interrupt control unit 250 is also set based on the above-described system specifications. Specifically, for example, the interrupt control unit 250 is set so that when an error signal Er output from a failure detection unit 420 that detects a failure in a transfer-origin processing unit 210 is enabled, the interrupt control unit 250 notifies a transfer-destination processing unit 210 by using an interrupt signal INT.

Next, in a step 51 (S51), each of the processing units 210 of the semiconductor device 40 performs a process defined as a system. It is desirable that a technique for facilitating the transfer of a process (i.e., the taking over of a process) when a failure occurs be incorporated into this process. Various techniques can be applied as such a technique. An example of such a technique is a technique in which a checkpoint in a checkpoint restart is stored in the shared resource 220A or the like.

Next, in a step 52 (S52), the failure detection unit 420 detects a failure. Upon detection the failure, the failure detection unit 420 enables the error signal Er.

Next, in a step 53 (S53), when the error signal Er is enabled, the update unit 401 of the task ID permission unit 400 updates the value in the register D based on the value of one of the registers F corresponding to the failed processing unit 210. Further, the interrupt control unit 250 notifies the transfer-destination processing unit 210 of the error signal Er output from the failure detection unit 420 based on the above-described initialization by enabling the interrupt signal INT.

Next, in a step 54 (S54), upon receiving the enabled interrupt signal INT, the processing unit 210 takes over, among the processes that have been executed by the failed processing unit 210, a process(es) that has been determined to be taken over in advance and executes the taken-over process(es). Note that as described above, various techniques such as a checkpoint restart can be applied to the transfer of the process.

The fourth embodiment has been explained above. According to the semiconductor device 40 in accordance with this embodiment, when a failure occurs in the processing unit 210, the management information of the task ID permission unit 400 is updated. That is, it is possible to change the task ID(s) that can be used by the processing unit 210 when a failure has occurred. That is, it is possible to update the register D at the time of the occurrence of a failure even under the circumstance in which the processing unit 210 cannot update the register D of the task ID permission unit 400 because, for example, the setting is locked (i.e., cannot be changed) or a writing operation is prohibited in the guard unit 410. Therefore, according to the semiconductor device 40, it is possible, in the system in which tasks that can be executed by each processing unit 210 are controlled based on management information, to enable a processing unit 210 to take over the process of a failed processing unit 210. That is, in the semiconductor device 40 according to this embodiment, it is also possible to provide a fault-tolerant system while securing the exclusive nature of resource access.

Note that as described previously, the guard unit 410 may also control access to the guard unit 410 itself by the processing unit 210 and access to the task ID permission unit 400 by the processing unit 210. Further, the update unit 401 may update the management information for the use of a task ID corresponding to a task for performing the initialization by using the register F. In such a case, the update unit 401 can change the management information so that when a failure occurs in the processing unit 210 that performs the initialization, another processing unit 210 can perform the task for performing the initialization. Therefore, when a failure occurs in the processing unit 210 that performs the initialization, the guard unit 410 can change the control of access to the guard unit 230 and the task ID permission unit 400 by the processing unit 210 according to the change by the update unit 401. Therefore, even if the processing unit 210 that performs the initialization fails before the completion of the initialization, another processing unit 210 can execute the process for the initialization. Consequently, it is possible to provide a system that is more fault-tolerant.

### Fifth Embodiment

Similarly to the third embodiment, a retry unit can be provided in the fourth embodiment. A fifth embodiment is explained hereinafter while omitting duplicated explanations. The fifth embodiment is obtained by modifying the fourth embodiment so that when a failure is detected more than a predetermined number of times, the control of access to the shared resource 220 and the like by the processing unit 210 is changed as in the case of the third embodiment. That is, in the fifth embodiment, when a failure is detected more than a predetermined number of times, the management information of the task ID permission unit 400 is updated and, as a result, the control of access to the shared resource 220 and the like by the processing unit 210 is changed.

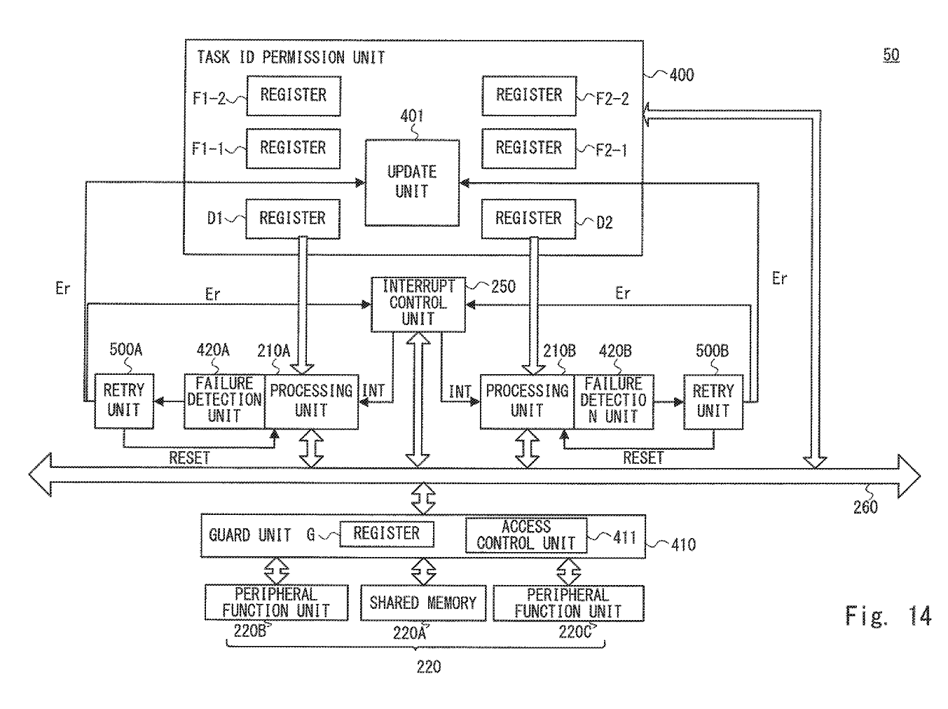

FIG. 14 is a block diagram showing a rough configuration example of a semiconductor device 50 according to the fifth embodiment. The semiconductor device 50 differs from the semiconductor device 40 according to the fourth embodiment in that the semiconductor device 50 includes retry units 500A and 500B. For the configuration and the operation of the semiconductor device 50, only differences from those of the semiconductor device 40 are explained hereinafter in detail and explanations of configurations and operations similar to those of the semiconductor device 40 are omitted as appropriate. Note that in the following explanation, the plurality of retry units 500A and 500B may be simply referred to as “the retry unit 500” when they do not need to be distinguished from each other. Note that the retry unit 500 shown in this embodiment may be added in the semiconductor device 40 according to the fourth embodiment and in a semiconductor device 40 according to a sixth embodiment (which will be described later).

The retry unit 500A is a retry control circuit that performs an operation similar to that of the retry unit 300A and retry unit 500B is a retry control circuit that performs an operation similar to that of the retry unit 300B. Note that in the example shown in FIG. 14, the retry unit 500A is disposed between a signal line of an error signal Er output from the failure detection unit 420A and signal lines of error signals Er input to the task ID permission unit 400 and the interrupt control unit 250. Further, the retry unit 500B is disposed between a signal line of an error signal Er output from the failure detection unit 420B and signal lines of error signals Er input to the task ID permission unit 400 and the interrupt control unit 250. Further, the retry unit 500 resets the failure-detected processing unit 210 when the error signal Er output from the failure detection unit 420 is enabled.

Similarly to the retry unit 300, the retry unit 500 enables each of the error signal Er that is output from the retry unit 500 and input to the task ID permission unit 400 and the error signal Er that is output from the retry unit 500 and input to the interrupt control unit 250 when the error signal Er output from the failure detection unit 420 is enabled more than a predetermined number of times.

When the error signal Er from the retry unit 500 is enabled, the management information is changed and the process is taken over as explained above in the fourth embodiment. Therefore, in the semiconductor device 50, when a failure is detected more than the predetermined number of times, the management information of the task ID permission unit 400 is updated. As a result, the control of access to the shared resource 220 by the processing unit 210 is changed. That is, the control by the guard unit 410 is changed. Note that the various modified examples described in the third embodiment can also be applied to this embodiment as long as no contradiction arises.

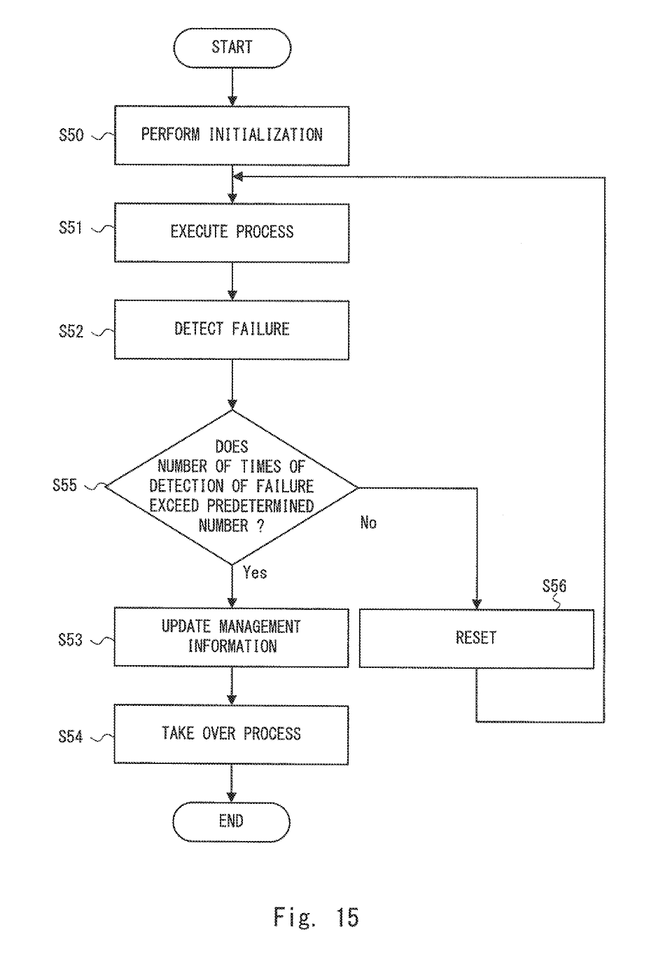

Next, an operation of the semiconductor device 50 is explained. FIG. 15 is a flowchart showing an example of an operation performed by the semiconductor device 50. The operation of the semiconductor device 50 is explained hereinafter along the flowchart shown in FIG. 15. Note that since an operation that is performed when a failure occurs is explained below, an example of an operation in which a failure occurs is shown by the flowchart. The flowchart shown in FIG. 15 differs from the flowchart shown in FIG. 13 in that the flowchart shown in FIG. 15 includes steps 55 and 56. The following explanation is given with particular emphasis on differences from the flowchart shown in FIG. 13.

Operations that are performed from the initialization to the failure detection are the same as those of the semiconductor device 40. Here, in the flowchart shown in FIG. 13, the process moves to the step 53 after the step 52. However, in this embodiment, the process moves to a step 55 after the step 52.

In the step 55 (S55), a process similar to the above-described process in the step 30 is performed. That is, the retry unit 500 determines whether or not the number of times of the detection of a failure in the same processing unit 210 exceeds a predetermined number. When the number of times of the detection of a failure in the same processing unit 210 has exceeded the predetermined number (Yes at step 55), the retry unit 500 enables the error signal Er output to the interrupt control unit 250 and the task ID permission unit 400. Then, the process moves to the step 53. On the other hand, when the number of times of the detection of a failure in the same processing unit 210 has not exceeded the predetermined number (No at step 55), the process moves to a step 56.

In the step 56 (S56), a process similar to the above-described process in the step 31 is performed. That is, the retry unit 500 resets the failure-detected processing unit 210. Then, the process returns to the step 51.

According to the semiconductor device 50, even when a failure is detected, the operation for taking over the process is not performed until the number of times of the detection exceeds the predetermined number. Therefore, it is possible to prevent the total processing capability of the system from being lowered due to transitory failures such as soft errors.

### Sixth Embodiment

Similarly to the second embodiment, the register that stores update information can be extended in the fourth embodiment. That is, the register F can be extended in a manner similar to that shown in the second embodiment. A sixth embodiment is explained hereinafter while omitting duplicated explanations.

In the semiconductor device 40 according to the fourth embodiment, when a failure occurs in a processing unit 210, the update unit 401 of the task ID permission unit 400 changes the management information so that another processing unit 210 that takes over the process of the failed processing unit 210 can use the task ID necessary for the transfer of the process.

In contrast to this, in this embodiment, when a failure occurs in a processing unit 210, the semiconductor device 40 further changes the management information so that a predetermined processing unit 210 is prohibited from using a predetermined task ID. That is, the update unit 401 updates the management information so that the failed processing unit 210 is prohibited from using a predetermined task ID. In this way, when a failure occurs in a processing unit 210, the guard unit 410 changes the access control so that another processing unit 210 that takes over the process of the failed processing unit 210 can access the shared resource 220 and the failed processing unit 210 is prohibited from accessing the shared resource 220. Note that the update by the update unit 401 is similar to that in the fourth embodiment. That is, when the update unit 401 according to this embodiment receives an enabled error signal Er, the update unit 401 updates the management information stored in the register D by using the update information stored in the register F.

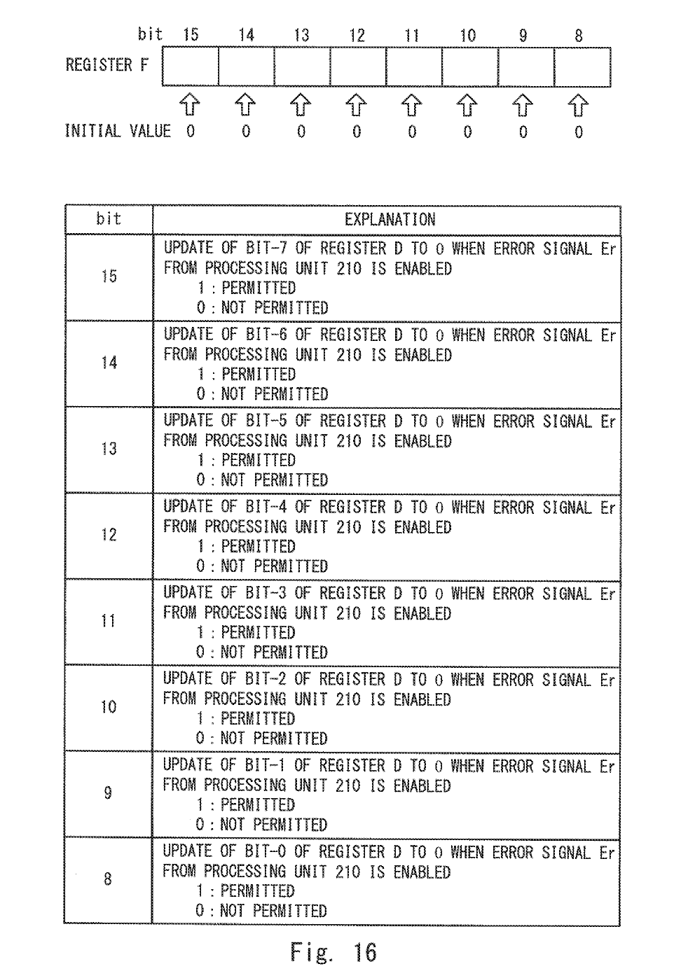

FIG. 16 is a diagram for explaining a structure example of the register F according to the sixth embodiment. In the example shown in FIG. 16, the register F is a register whose bit width is 16 bits. Specifically, the register F according to this embodiment includes additional 8 bits as bits for changing management information so as to prohibit the use of task IDs in addition to the 8 bits shown in the fourth embodiment. Note that FIG. 16 shows only the additional high-order 8 bits. For example, as shown in FIG. 16, each of the bits of the register F holds the following value.

The bit-15 holds a value for specifying permission/prohibition of writing of 0 into the bit-7 of the register D when the error signal Er from the failure detection unit 420 is enabled. Note that when 1 is held in this bit, it means that when the processing unit 210 has failed, the value in the bit-7 of the register D is updated to 0 by the update unit 401. That is, after the update by the update unit 401, the use of the task ID 7 by the processing unit 210 corresponding to this register D is prohibited. On the other hand, when 0 is held in this bit, it means that when the processing unit 210 has failed, the value in the bit-7 of the register D is not updated to 0 by the update unit 401. That is, the permission/prohibition state of the use of the task ID 7 by the processing unit 210 corresponding to this register D is not changed.

For example, when a failure occurs in the processing unit 210A, the register D1 is updated by using the register F1-1 and the register D2 is updated by using the register F2-1. In this process, for example, when 1 is held in the bit-15 of the register F1-1, the register D1 is updated by the update unit 401 and the use of the task ID 7 by the processing unit 210A is prohibited. Further, for example, when 0 is held in the bit-15 of the register F2-1, the register D2 is updated by the update unit 401 but the permission/prohibition state of the use of the task ID 7 by the processing unit 210B is not changed.

The above-described matters hold true for each of the bit-14 to bit-8 of the register F. That is, the bit-K (K is 15 to 8) of the register F holds a value for specifying the permission/prohibition of writing of 0 into the bit-(K-8) of the register D (i.e., a value for specifying the permission/prohibition of the change for prohibiting the use of the task ID (K-8)) when the error signal Er from the failure detection unit 420 is enabled. Note that the initial value of each bit shown in FIG. 16 is merely an example. That is, they may be arbitrarily changed according to the characteristic of the system.

Next, an operation of the semiconductor device 40 according to this embodiment is explained. Note that in the following explanation, the flowchart for the semiconductor device 40 according to the fourth embodiment shown in FIG. 13 is used. Further, the following explanation is given with particular emphasis on differences from the operation of the semiconductor device 40 according to the fourth embodiment.

In a step 50 (S50), the semiconductor device 40 carries out the initialization of the system. Note that for the register F, the semiconductor device 40 according to this embodiment sets a value for the above-described additional high-order 8 bits in addition to the 8 bits shown in the fourth embodiment. The setting of these values is determined based on the system specifications.

Next, in a step 51 (S51), each of the processing units 210 of the semiconductor device 40 performs a process defined as a system. Then, in a step 52 (S52), the failure detection unit 240 detects a failure.

Then, in a step 53 (S53), when the error signal Er is enabled, the update unit 401 of the task ID permission unit 400 updates the value in the register D based on the value of one of the registers F corresponding to the failed processing unit 210. In this process, in this embodiment, the register D is updated based on the value of the register F which is extended as describe above. Further, the interrupt control unit 250 notifies the transfer-destination processing unit 210 of the error signal Er output from the failure detection unit 240 by enabling the interrupt signal INT.

Next, in a step 54 (S54), upon receiving the enabled interrupt signal INT, the processing unit 210 takes over, among the processes that have been executed by the failed processing unit 210, a process(es) that has been determined to be taken over in advance and execute the taken-over process(es).

The sixth embodiment has been explained above. As described previously, when a failure occurs in a processing unit 210, the semiconductor device 40 according to this embodiment changes the management information so that another processing unit 210 that takes over the process of the failed processing unit 210 can use the task ID necessary for the transfer of the process, and changes the management information so that the failed processing unit 210 is prohibited from using the task ID. As described above, in this embodiment, when the register D is updated at the time of the failure of the processing unit 210, the register D can be updated for prohibiting the use of the task ID as well as for permitting the use of the task ID. In this way, since access from the failed processing unit 210 can be blocked by the guard unit 410, a malfunction which would otherwise be caused by the failed processing unit 210 can be prevented. Further, in the case where various information items indicating processing states and the like are stored, it is possible to prevent such various information items from being corrupted due to access from the failed processing unit 210. Note that in the above-shown embodiment, an example in which the register F of the fourth embodiment is extended is shown. However, instead of extending the register F, a separate register (i.e., an additional register) may be provided.

The present invention made by the inventors has been explained above in a specific manner based on embodiments. However, the present invention is not limited to the above-described embodiments, and needless to say, various modifications can be made without departing from the spirit and scope of the present invention. For example, in the above-described embodiments, examples in which the register C or G is provided as the access restriction information storage unit and the registers E1 and E2 are provided as the update information storage units are shown. However, when the access control by the guard unit 230 and the update of the control are implemented by, for example, a combinational circuit(s), the access restriction information storage unit and the update information storage unit are not necessarily indispensable. Further, similarly, in the above-described embodiments, examples in which the register D is provided as the management information storage unit and the register F is provided as the management update information storage unit are shown. However, when the update by the task ID permission unit 400 is implemented by, for example, a combinational circuit, the management information storage unit and the management update information storage unit are not necessarily indispensable.

Further, in the above-described embodiments, examples in which only one of the processing units 210 fails are explained. However, needless to say, even when a plurality of processing units 210 have simultaneously failed, the change of the access control by the guard unit 230 or 410 can be similarly carried out. Note that when failures in a plurality of processing unit 210 are simultaneously detected, the update unit 232 may update the content of the access restriction information storage unit by referring to one of the update information storage units corresponding to the failed processing units 210 that is determined to be preferentially referred to in advance. Alternatively, the content of the access restriction information storage unit may be updated by referring to all the update information storage units corresponding to the failed processing units 210 and merging the update contents stored in these update information storage units. Similarly, when failures in a plurality of processing unit 210 are simultaneously detected, the update unit 401 may update the content of the management information storage unit by referring to one of the management update information storage units corresponding to the failed processing units 210 that is determined to be preferentially referred to in advance. Alternatively, the content of the management information storage unit may be updated by referring to all the management update information storage units corresponding to the failed processing units 210 and merging the update contents stored in these management update information storage units.

Further, in the above-described embodiments, configuration examples in which access to the guard unit 230 or 410 by the processing unit 210 is also controlled by the guard unit 230 or 410 is shown. However, needless to say, the guard unit 230 or 410 may control only the access to the shared resource 220.

The first to sixth embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A semiconductor device comprising:
a plurality of processing units;
a shared resource shared by the plurality of processing units; and
a guard unit, wherein
the guard unit restricts and thereby controls access to the shared resource by the processing unit, and
the guard unit changes, when a processing unit has failed, control of access so that another processing unit that takes over a process of the failed processing unit is permitted to access at least a part of an access destination which the failed processing unit has been permitted to access.

2. The semiconductor device according to claim 1, wherein the guard unit further changes, when the processing unit has failed, the control of access so that the failed processing unit is prohibited from accessing the access destination.

3. The semiconductor device according to claim 1, further comprising a reset unit configured to reset a processing unit every time a failure is detected in the processing unit, wherein
the guard unit changes the control of access when the number of times of detection of a failure exceeds a predetermined number in any of the processing units.

4. The semiconductor device according to claim 1, wherein the guard unit further restricts and thereby controls access to the guard unit itself, and changes, when a processing unit that is permitted to access the guard unit has failed, the control of access so that another processing unit other than the failed processing unit is permitted to access the guard unit.

5. The semiconductor device according to claim 1, wherein the guard unit comprises:
an access restriction information storage unit configured to store access restriction information for specifying a restriction on access to the shared resource by the processing unit;
an access control unit configured to control access by the processing unit in accordance with the access restriction information stored in the access restriction information storage unit; and
an update unit configured to update the access restriction information stored by the access restriction information storage unit.

6. The semiconductor device according to claim 5, wherein
the guard unit further comprises an update information storage unit configured to store update information for updating the access restriction information stored in the access restriction information storage unit, and
the update unit updates the access restriction information stored in the access restriction information storage unit by using the update information stored in the update information storage unit.

7. The semiconductor device according to claim 1, further comprising a management unit configured to manage, for each of the processing units, identification information available to the processing unit, the identification information being information for identifying a process, wherein
the management unit changes, when the processing unit has failed, management so that the another processing unit that takes over the process of the failed processing unit can use the identification information corresponding to that process,
the processing unit executes a process corresponding to the identification information that is managed as available to the processing unit in the management unit and notifies the guard unit of the identification information corresponding to the process to be executed when the processing unit accesses the shared resource, and
the guard unit controls access by the processing unit according to the identification information and changes, when the processing unit has failed, the control of access according to a change by the management unit.

8. The semiconductor device according to claim 7, wherein the management unit comprises:
a management information storage unit configured to store management information for specifying the identification information available to the processing unit, and
a management information update unit configured to update the management information stored in the management information storage unit.

9. The semiconductor device according to claim 8, wherein
the management unit further comprises a management update information storage unit configured to store update information for updating the management information stored in the management information storage unit, and
the management information update unit updates the management information stored in the management information storage unit by using the update information stored in the management update information storage unit.

10. A semiconductor device comprising:
a plurality of processing units;
a shared resource shared by the plurality of processing units;
a management unit configured to manage, for each of the processing units, identification information available to the processing unit, the identification information being information for identifying a process; and
a guard unit configured to restrict and thereby control access to the shared resource by the processing unit, wherein
the processing unit executes a process corresponding to the identification information that is managed as available to the processing unit in the management unit and notifies the guard unit of the identification information corresponding to the process to be executed when the processing unit accesses the shared resource,
the management unit changes, when the processing unit has failed, management so that the another processing unit that takes over a process of the failed processing unit can use the identification information corresponding to that process, and
the guard unit controls access by the processing unit according to the identification information.

11. An access management method comprising:
executing a process by a plurality of processing units while restricting and thereby controlling access to a shared resource by each of the plurality of processing units;
detecting a failure in each of the plurality of processing units; and
changing, when a processing unit has failed, control of access so that another processing unit that takes over a process of the failed processing unit is permitted to access at least a part of an access destination which the failed processing unit has been permitted to access.

12. The access management method according to claim 11, wherein when the processing unit has failed, the control of access is changed so that the failed processing unit is prohibited from accessing the access destination.

13. The access management method according to claim 11, wherein
the processing unit is reset every time a failure is detected in the processing unit, and
when the number of times of detection of a failure exceeds a predetermined number in any of the processing units, the control of access is changed so that another processing unit that takes over a process of the failed processing unit is permitted to access at least apart of an access destination which the failed processing unit has been permitted to access.

14. The access management method according to claim 11, wherein
for each of the processing units, identification information available to the processing unit is managed, the identification information being information for identifying a process,
when the processing unit has failed, management is changed so that another processing unit that takes over a process of the failed processing unit can use the identification information corresponding to that process,
the processing unit executes a process corresponding to the identification information that is managed as available to the processing unit and sends the identification information corresponding to the process to be executed when the processing unit accesses the shared resource,
the access by the processing unit is controlled according to the identification information that is used when the processing unit performs the execution, and
when the processing unit has failed, the control of access is changed according to a change in the management.
